(19) United States
(12) Patent Application Publication
(10) Pub. No.: US 2024/0231201 A9
(43) Pub. Date: Jul. 11, 2024

(54) PROJECTED AV DATA, HUD AND VIRTUAL AVATAR ON VEHICLE INTERIOR

(71) Applicant: GM Cruise Holdings LLC, San Francisco, CA (US)

(72) Inventor: Burkay Donderici, Burlingame, CA (US)

(21) Appl. No.: 17/970,040

(22) Filed: Oct. 20, 2022

(51) Int. Cl. G03B 21/14; B60K 35/00; G06F 3/01

(52) U.S. Cl. CPC G03B 21/14; B60K 35/00; G06F 3/013; B60K 2370/149; B60K 2370/334

(57) ABSTRACT

Systems and techniques are described for generating visual projections of information for display on surfaces within a vehicle. An example method can include determining, based on sensor data, candidate surfaces on which to project visual information for a person within a vehicle, the candidate surfaces residing in an interior of the vehicle; based on the sensor data, determine, for each candidate surface, a discernability of the visual information when projected onto the candidate surface, the discernability being determined based on attributes of the candidate surface and the visual information; based on the discernability of each candidate surface, select a particular candidate surface from the candidate surfaces as a target surface for projecting the visual information, the particular candidate surface being associated with at least a threshold amount of discernability of the visual information when projected onto the particular candidate surface; and project the visual information onto the particular candidate surface.

### BACKGROUND

### 1. Technical Field

The present disclosure generally relates to using sensors and devices within a vehicle to generate intelligent visual projections for users within the vehicle. More specifically, the present disclosure is directed to determining a pose of a passenger of a vehicle based on sensor data from one or more sensors in the vehicle, and projecting light and/or images on internal surfaces of the vehicle based at least on, for example, the pose of the passenger and/or the characteristics of the surfaces of the vehicle.

### 2. Introduction

An autonomous vehicle (AV) is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example autonomous vehicle (AV) environment, according to some examples of the present disclosure.

FIG. 2 illustrates an example view of an interior of a vehicle with sensors and projectors for implementing aspects of the present disclosure.

FIG. 3 illustrates an example process for projecting visual information for passengers of an autonomous vehicle, according to some examples of the present disclosure.

FIG. 4 illustrates an example process for determining where to project visual information for a target person based on a determination that a target person's view to a projection of visual information is or is not obstructed, according to some examples of the present disclosure.

FIG. 5 illustrates an example process for projecting visual information on an identified display area, according to some examples of the present disclosure.

FIG. 6 illustrates different example depictions of a projector projecting visual information onto surfaces within a vehicle at different moments in time, according to some examples of the present disclosure.

FIG. 7 illustrates an example display area used to project visual information, according to some examples of the present disclosure.

FIG. 8 illustrates an example object that is in a position relative to a first projector that would block a projection made by that first projector, according to some examples of the present disclosure.

FIG. 9A illustrates an example scene with multiple projectors projecting portions of visual information onto different portions of a surface of a vehicle, according to some examples of the present disclosure.

FIG. 9B illustrates projections based on a target person's attention, according to some examples of the present disclosure.

FIG. 10 is a flowchart illustrating an example process for projecting visual information onto surfaces of a vehicle, according to some examples of the present disclosure.

FIG. 11 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Described herein are systems, apparatuses, processes (also referred to as methods), and computer-readable media (collectively referred to as “systems and techniques”) for dynamically providing visual information to passengers of a vehicle such as, for example, individuals entering the vehicle, individuals located withing the vehicle, and/or individuals exiting the vehicle. The systems and techniques described herein can provide such visual information using light projections. Information may be projected onto almost any surface within a vehicle, including but not limited to, a dashboard, a door, a seat, a floor, a window of the vehicle, a body part of a person, or any combination thereof, among other surfaces.

Visual information may be projected onto surfaces using light. Moreover, the visual information can be projected using light with certain characteristics that ensure that the light used to depict the visual information, when projected on a surface, can be seen by the human eye. The characteristics of the light can include, for example and without limitation, a color of the light (e.g., a different color than the color of the surface on which the light will be projected, etc.), a pattern of the light (e.g., a pattern that is different than a pattern of the surface on which the light will be projected or any other pattern), a light intensity, a shape or configuration of the light relative to a shape or configuration of the surface on which the light will be projected, a rendering configuration of the light (e.g., flashing the light onto a surface, steadily projecting the light for a period of time without interruptions and/or threshold variations in characteristics of the projected light during the period of time, etc.) and/or any other characteristics. For example, light may be projected onto surfaces using certain colors that are different from a color(s) of a selected display surface/area within the vehicle.

To illustrate, when projecting a visual message onto a white surface of the vehicle using light, the vehicle can avoid projecting the visual message in white as the white message projected onto a white surface could render the message difficult to see, discern, and/or perceive by the human eye. Similarly, when projecting a visual message onto a black surface of the vehicle using light, the vehicle can avoid projecting the visual message in black as the black message projected onto a black surface could render the message difficult to see, discern, and/or perceive by the human eye. Thus, when projecting light onto a surface, the projected light can be configured in a different color than the color of the surface on which the light is projected.

For example, white letters may be projected onto a black surface (or a different color other than white, such as any color that is lighter than the black surface or any color that creates a contrast with the black surface), or black letters may be projected onto a white surface (or a different color other than black, such as any color that is darker than the white surface or any color that creates a contrast with the white surface). Surfaces that include patterns that may make a light projection (e.g., a projected image, a projected visual message, a projected light pattern, a projected video or animation, a projected light, etc.) difficult to discern by a human eye from the surface on which it is projected may be avoided. In certain instances, surfaces that are uniform in color and free from patterns may be selected as a display area.

The surfaces (and characteristics thereof) to be avoided when projecting visual information and/or the surfaces used to project the visual information can be detected using one or more sensors of the vehicle, such as a camera sensor, a light detection and ranging (LIDAR) sensor, a radio detection and ranging (RADAR) sensor, an inertial measurement unit (IMU), a combination thereof, and/or any other sensor. In some examples, a surface on which to project visible information (e.g., light, etc.) can be selected based on one or more characteristics of the surface such as, for example and without limitation, a color(s) of the surface, a pattern(s) of the surface, a shape of the surface, a texture of the surface, a location of the surface relative to a field-of-view (FOV) of a passenger of the vehicle, a location of any obstructions located between the surface and the passenger and within a FOV of the passenger, and/or any other characteristics. The characteristics of surfaces within the vehicle can be detected using one or more sensors of the vehicle, such as a camera sensor, a LIDAR, a RADAR sensor, an IMU, and/or any other sensor. Moreover, the FOV of a passenger can be determined based on such sensor data. For example, a FOV of a passenger can be determined based on a pose of the passenger estimated using sensor data and/or characteristics of a vision of a human eye(s). The FOV of the passenger can be estimated to ensure the projected light is within the FOV of the passenger.

As previously noted, the systems and techniques described herein can be used to project visual information on surfaces within a vehicle for one or more passengers of the vehicle. Sensor data may be received from one or more sensors of the vehicle such as, for example and without limitation, a camera sensor, a LIDAR, a RADAR, an IMU, and/or any other sensor. The sensor data may allow one or more processors of the vehicle to identify suitable locations (e.g., locations that are large enough to fit the visual information, locations that are within a FOV of a passenger associated with the visual information, locations with surfaces having one or more characteristics that can allow a human eye to discern the visual information projected on such surfaces given the characteristics of the visual information relative to the one or more characteristics of the surfaces, locations that are free of obstructions located within the FOV of a passenger and which may at least partially obstruct a view of the passenger to the visual information, etc.) within a vehicle onto which visual information, such as light, animations, videos, messages, patterns, shapes, and/or images, may be projected.

The visual information can be used to provide certain information to a passenger(s) of the vehicle, draw the passenger's attention to something in or out of the vehicle, provide one or more messages to the passenger(s) of the vehicle, provide visual depictions of certain information and/or things to the passenger(s), and/or to provide any other visual information and/or depiction. For example, in some cases, visual information can be used to instruct an individual where to sit within the vehicle. To illustrate, individuals entering a vehicle may be instructed to sit in a particular or designated seat using a light projection, such as a projected avatar, a projected shape or pattern, and/or a projected a visual message, that highlights and/or identifies the seat and/or otherwise draws the individual's attention to the seat. For example, one or more processors of the vehicle can use sensor data (e.g., from one or more sensors such as, for example, a camera sensor, a LIDAR, a RADAR, etc.) to detect an area (e.g., a seat in the vehicle) on which an individual entering the vehicle should sit. The one or more sensors can detect any seats in the vehicle that are available to sit for the individual (e.g., that are not already in use by another individual and/or that are not obstructed by an object on the seat or transported on the seat, etc.), and select an available seat on which the individual should sit during the trip (or at least a first segment of the trip).

In some examples, the one or more processors can select the available seat from a number of available seats based on one or more factors such as, for example and without limitation, a size and/or shape of the individual entering the vehicle relative to respective sizes and/or shapes of seats in the vehicle, an estimated side of the vehicle in which the individual is estimated/predicted to exit the vehicle (e.g., given the estimated location of the vehicle when parked to allow the individual to exit the vehicle) relative to a location of a destination associated with the individual, safety considerations when entering or exiting the vehicle (e.g., the selected seat can be a seat located on a side of the vehicle on which the individual should exit the vehicle at the destination location because it is safer to exit the vehicle from the side of the vehicle in which the seat is located relative to other sides of the vehicle), an order in which the individual and other passengers are expected to exit the vehicle, etc. For example, if the one or more processors determine that the individual will need to exit on the right side of the vehicle when the vehicle reaches the destination of the individual, the one or more processors can select a seat on the right side of the vehicle. As another example, if the one or more processors determine that it is safer for the individual to exit the vehicle from the right side of the vehicle when the vehicle reaches the destination of the individual than the left side of the vehicle, the one or more processors can select a seat on the left side of the vehicle. As yet another example, if the one or more processors determine that the individual will need to exit the vehicle before a first passenger and after a third passenger (e.g., because the individual's destination will be reached by the vehicle after the destination or the first passenger but before the destination of the third passenger, or because of any other reason), the one or more processors can select a seat on the vehicle that, when used by the individual to sit in the vehicle during a trip, the individual seated in the seat will not obstruct an exit path of the first passenger and a path of the individual to exit the vehicle will not be obstructed by the third passenger estimated/predicted to exit the vehicle after the individual.

Once the one or more processors have identified a seat for the individual, the one or more processors can trigger a projection device (e.g., a projector, an optical system with projecting capabilities, and/or any other light projector or light emitting device) to project visual information, such as an avatar, to instruct the individual where to sit within the vehicle. In some examples, the visual information (e.g., the avatar or any other light projection) can be projected onto a surface of the area (e.g., a seat) where the individual should sit to indicate to the individual that the individual should sit in the area associated with the surface on which the visual information is projected. Thus, the projected visual information can indicate to the individual that the individual should sit at the location where the visual information is projected. In other examples, the visual information (e.g., an avatar or any other visual information) can be projected in an area estimated to be visible by the individual entering the vehicle. For example, the one or more processors can obtain sensor data depicting the area relative to one or more things such as, for example, the individual, one or more objects in the vehicle, etc. The one or more processors can determine, based on the sensor data, that if the visual information is projected onto the area, a view of the individual to the visual information projected on the area will not be obstructed by one or more objects, and/or that the visual information when projected onto the area will be discernable by the human eye given one or more characteristics of the area and the visual information (e.g., a respective color, a respective pattern, a respective shape, a respective texture, etc.). In some cases, the visible light can be depicted with certain animations used to draw the individual's attention and/or provide information to the individual. For example, when projected onto the area (e.g., a seat), the visible information can be depicted making a gesture (e.g., pointing to, motioning towards, etc.) that indicates where the individual should sit within the vehicle.

Areas where visual information (e.g., images, videos, animations, messages, light patterns, and/or other light projections) are projected may be selected such that the visual information when projected on such areas will not be obscured by the area (e.g., by a characteristic of the area such as a color, texture, pattern, shape, configuration, etc.). As the vehicle drives down a roadway, as individuals enter the vehicle and need to identify where to sit, and/or as individuals in the vehicle prepare to exit the vehicle, visual information may be provided to the individuals within the vehicle. In some examples, the one or more processors of the vehicle may receive, interpret, and respond to user voice and/or gesture commands. For example, a passenger may point to a region of the vehicle, such as a row of seats, and utter the voice command “please let me know where to sit within this row of seats in the vehicle”. The one or more processors can detect and recognize the passenger's gesture (e.g., pointing to the row of seats) and the passenger's utterance, and respond by projecting visual information indicating where the passenger should sit within the row of seats in the vehicle.

If a passenger exits the vehicle and leaves behind a personal object, the one or more processors of the vehicle can trigger a projection device(s) to generate a light projection highlighting a location where that personal object resides to draw the passenger's attention to that location so the passenger can see and grab the personal object, and/or otherwise informing the passenger that a personal object was left behind in the vehicle. In some examples, the light projection can visually highlight the personal object and/or an area around the personal object. For example, the light projection may shine on and/or encircle the personal object and/or otherwise draw the person's attention to the location of the personal object. In some examples, the highlighting may include flashes of projected light or any other pattern of light on or around the personal object. In some cases, the one or more processors may provide audio messages to persons within the vehicle. For example, the one or more processors can trigger one or more speaker devices of the vehicle to emit audio for one or more passengers of the vehicle. The audio can be emitted in addition to or in association with one or more projections of visual information.

For example, the audio can supplement the projection of visual information so that both visual and audio information are provided to the passenger(s). To illustrate, using the previous example where visual information is projected to inform a passenger that the passenger may be leaving behind a personal object, the one or more processors can trigger an audio output by a speaker device(s) to communicate to the passenger that the passenger is leaving behind a personal object and/or to communicate information about the visual information being projected, such as an audio alert drawing the attention of the passenger to the location where the visual information is projected and where the personal object is located.

The systems and techniques described herein can identify when obstructions within the vehicle will interfere with a projection of visual information onto a surface. For example, one or more processors of the vehicle can obtain data from one or more sensors (e.g., one or more camera sensors, LIDARs, RADARs, etc.) on the vehicle depicting a position of a passenger, a position of an intended surface on the vehicle on which to project visual information, a position of any objects or obstructions that may impair or block the passenger's view to the surface on which to project visual information, etc. Using the sensor data (e.g., which depicts and/or indicates a position of the passenger within the vehicle, a location of one or more surfaces within the vehicle, the position of one or more objects within the vehicle, etc.), the one or more processors can determine that a particular object may obstruct the passenger's view to visual information projected on a particular surface of the vehicle that the one or more processors determined are adequate surfaces for projecting visual information. The one or more processors can determine such obstruction of the passenger's view based on a position of the passenger relative to the location of that particular surface, a position of a first projector device relative to the location of that particular surface, and a position of the particular object relative to the location of the surface and the position of the first projector (and/or the passenger). For example, the one or more processors can determine that the particular object is within a path from the eyes of the passenger to the surface and that certain characteristics of the object (e.g., a size of the object, a shape of the object, a transparency of the object, etc.) are estimated to at least partially impair the passenger's view of visual information projected onto the particular surface.

To illustrate, the one or more processors can use data from one or more sensors in the vehicle to determine a position of a first passenger of the vehicle, a position of a head of a second passenger, a position of a projector device within the vehicle, and the location of a surface selected for projecting visual information onto that surface. The one or more processors can then determine, based on the location of the surface and the positions of the first passenger, the head of the second passenger, and the projector device, that the head of the second passenger would block the visual information if such visual information is projected on the surface from the first projector device. In some cases, if the one or more processors detect that visual information projected from a first projector device to a location within the vehicle will be obstructed by one or more objects, such as the head of the second passenger in the previous example, the one or more processors can select one or more different projector devices to use to project the visual information onto the surface.

For example, the one or more processors can determine, based on data from one or more sensors in the vehicle, a position of the first passenger of the vehicle, a position of a head of the second passenger, a position of the first projector device within the vehicle, a respective position of one or more additional projector devices within the vehicle, and the location of the surface selected for projecting visual information onto that surface. The one or more processors can use such information (e.g., the position of the first passenger, the position of the head of the second passenger, the position of the first projector device, the respective position of the one or more additional projector devices, and the location of the surface) to determine that the head of the second passenger may obstruct a view of the first passenger to visual information projected on the surface.

However, the one or more processors can determine (e.g., based on the information above) that a view of the first passenger to the visual information would not be obstructed if the visual information is projected on the surface from a second projector device of the one or more additional projector devices. For example, the one or more processors can determine that a view of the first passenger to the visual information would not be obstructed if the visual information is projected on the surface from a second projector device given the position of the first passenger, the location of the surface, and the position of the second projector device relative to the location of the surface and the position of the first passenger (as well as, in some cases, the position of other passengers and/or objects in the vehicle). The one or more processors can then select to use the second projector device to project the visual information on the surface rather than using the first projector device to project the visual information on the surface.

Data from one or more sensors within the vehicle can be used to detect any potential obstructions to visual information projections. To illustrate, in the example above, the one or more processors can use data from one or more sensors within the vehicle to determine that the head of the second passenger would block/obstruct a viewing path of the first passenger to the visual information projected on the surface and/or that the head of the second passenger would block/obstruct the surface. The one or more processors can also use the data from the one or more sensors to determine that the surface and a projection path from the second projector device to the surface would not be obstructed/blocked by the second passenger and/or any objects within the vehicle. As previously noted, the second projector device may be selected based on the location and pose of the first passenger within the vehicle, the position of the second projector relative to the first passenger and the surface, the location of the surface relative to the first passenger and the second projector device, and the location and pose of the second passenger. Such determinations may be made using data from sensors in the vehicle.

The visual information displayed on a surface of the vehicle can include any type of information. For example, the visual information may include instructional information, information responsive to a user inquiry, information about the trip, information about the vehicle, information about the geographical location of the vehicle, educational information, alerts or warnings, information associated with a transaction, notifications, and/or any other type of information. For example, in some cases, such information may include projecting an avatar that shows a passenger of the vehicle which seat of the vehicle that the passenger should sit in. Other non-limiting examples of visual information may include driving instructions, information indicating a location of an item that a passenger of the vehicle may have forgotten or left behind when exiting the vehicle, information guiding a user on how to perform an action (e.g., where to sit within the vehicle, how to exit the vehicle, how to enter the vehicle, how to access an item such as a device within the vehicle, change a sitting posture, stop a particular activity, initiate a particular activity, etc.), and/or any other information. The sensors used by the systems and techniques described herein can include, for example and without limitation, a camera sensor, a LIDAR, a RADAR, an IMU, other imaging devices, and/or any other sensors and/or combination of sensors.

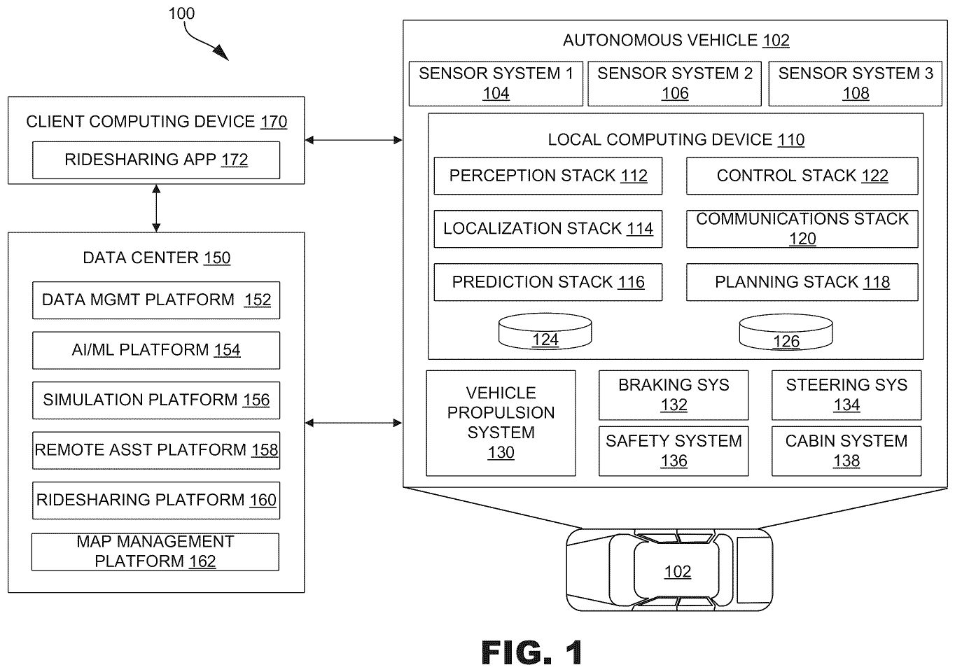

Examples of the systems and techniques described herein are illustrated in FIG. 1 through FIG. 7 and described below.

FIG. 1 is a diagram illustrating an example autonomous vehicle (AV) management system 100, according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked/obstructed from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the application 172 client application 172 to enable passengers to view the AV 102 in transit enroute to a pick-up or drop-off location, and so on.

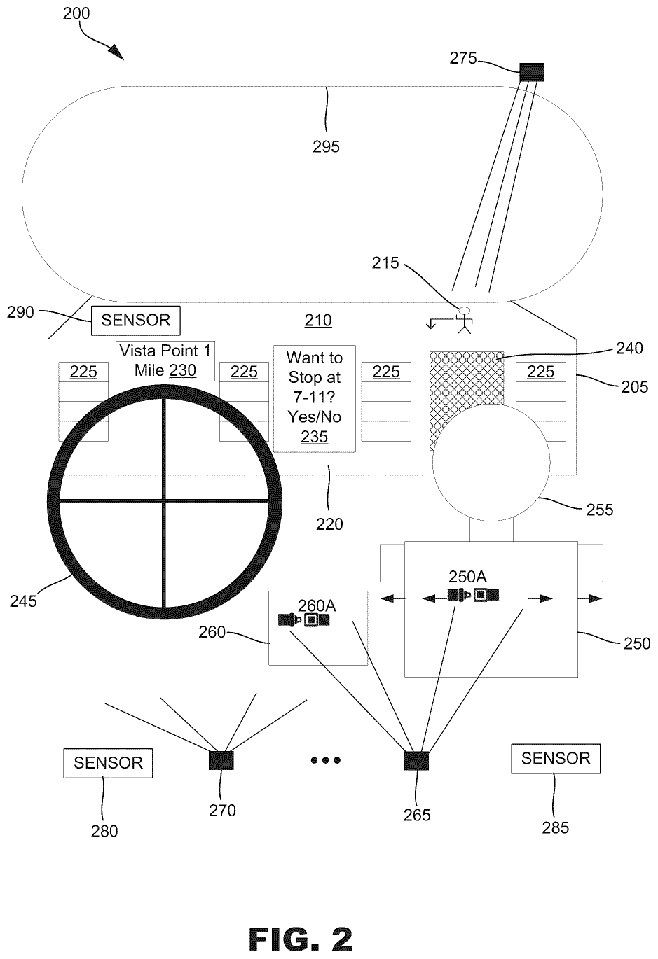

FIG. 2 illustrates an example view of an interior 200 of a vehicle (e.g., AV 102) with sensors and projectors for implementing the systems and techniques described herein, in accordance with some examples of the disclosure. In this example, the interior 200 includes a windshield 295 of the vehicle, a top portion 210 of a dashboard 205 of the vehicle, a side portion 220 of the dashboard 205 of the vehicle, a steering wheel 245 of the vehicle, a back portion of an occupant 250 of the vehicle, the head 255 of the occupant 250 of the vehicle, a purse 260 of a person in the vehicle such as the occupant 250 or another person, projectors 265, 270, and 275 of the vehicle, and sensors 280, 285, and 290 of the vehicle.

The sensors 280, 285, and 290 of the vehicle can include any type of sensor such as, for example and without limitation, a camera sensor, a LIDAR sensor, a RADAR sensor, an IMU, a motion sensor, a thermal camera sensor, a time-of-flight (TOF) sensor, a global positioning system (GPS) receiver, and/or any other type of sensor. In some examples, the sensors 280, 285, and 290 of the vehicle can be the same as the sensor systems 104, 106, and 108 shown in FIG. 1. In other examples, one or more of the sensors 280, 285, and 290 of the vehicle can be different than the sensor systems 104, 106, and/or 108. Moreover, the projectors 265, 270, and 275 can include any type of projector devices and can be arranged and/or placed in any area of the vehicle such as, for example and without limitation, a door panel(s) in the interior 200 of the vehicle, a ceiling of the interior 200 of the vehicle, a seat(s) on the vehicle, the windshield 295 of the vehicle, the dashboard 205 of the vehicle, a rear window of the vehicle, a side window of the vehicle, and/or any other area of the vehicle. The number and placement of sensors and projectors in FIG. 2 are merely examples provided for explanation purposes. In other examples, the interior 200 of the vehicle can include more or less sensors than the sensors 280, 285, and 290 shown in FIG. 2, more or less projectors than the projectors 265, 270, and 275 shown in FIG. 2, and/or a different arrangement/placement of sensors and/or projectors than the arrangements/placements shown in FIG. 2.

In this example, the interior 200 includes an avatar 215 of a person projected by a projector 275 of the vehicle onto a surface of the interior 200 of the vehicle. Specifically, in this example, the avatar 215 has been projected on the top portion 210 of the dashboard 205. The avatar 215 can be projected by the projector 275 after the local computing device 110 of the vehicle determines that the top portion 210 of the dashboard 205 is within a FOV of a target person in the vehicle (or entering or exiting the vehicle), a view of that target person to the projected avatar 215 on the surface of the top portion 210 of the dashboard 205 is not impaired or obstructed by any objects or occupants in the vehicle, and the surface of the top portion 210 of the dashboard 205 is an adequate surface (e.g., given the characteristics of the avatar 215 and the characteristics of the surface such as, for example, color, texture, pattern, illumination levels, etc.) for projecting the avatar 215, as further described herein. A surface can be determined to be an adequate surface for projecting visual information, such as the avatar 215, based on the relative characteristics of the surface and the visual information to be projected (e.g., the colors, textures, patterns, shapes, dimensions, etc.), as further described herein.

The local computing device 110 of the vehicle can use data from one or more of the sensors 280, 285, and/or 290 to determine that the top portion 210 of the dashboard 205 is within the FOV of the target person in the vehicle (or entering or exiting the vehicle), the view of that target person to the projected avatar 215 on the surface of the top portion 210 of the dashboard 205 is not impaired or obstructed by any objects or occupants in the vehicle, and the surface of the top portion 210 of the dashboard 205 is an adequate surface for projecting the avatar 215. The sensors 280, 285, and/or 290 can perceive the surface of the top portion 210 of the dashboard 205 (and any other surface) from different relative angles, distances, views, and/or resolutions. The different relative angles, distances, views, and/or resolutions can ensure that the local computing device 110 can perceive the surface of the top portion 210 of the dashboard 205 from at least one sensor; can allow the local computing device 110 to obtain a better and/or more complete view and/or representation of the surface of the top portion 210 of the dashboard 205, characteristics of that surface, positions (e.g., angles, distances, etc.) of the surface relative to a target person in the vehicle, and/or positions of the surface relative to one or more of the projectors 265, 270, and 275 on the vehicle; and/or a more complete and/or accurate “picture” and/or understanding of any potential obstructions to a projection onto the surface, a view of the surface by the target person (e.g., from a position of the target person and/or a future, predicted position of the target person), a view of the sensors 280, 285, and/or 290 to the surface, and/or a view of the projectors 265, 270, and 275 to the surface.

In some examples, the multiple projectors (e.g., projectors 265, 270, and 275) in the interior 200 of the vehicle can be used to avoid obstructions that may block a person's visibility of a projection of visual information. For example, assume that the projector 265 is projecting visual information onto a surface of the interior 200 of the vehicle and the occupant 250 of the vehicle moves (or moves a body part such as the head 255 or an arm/hand, for example) and such move creates an obstruction (e.g., caused by the occupant 250 or a body part of the occupant 250 after moving) of the visual information being projected by the projector 265. In this example, one or more of the sensors 280, 285, and/or 290 can detect that a view of a target person to the projection of the visual information is obstructed by the occupant 250 (or a body part thereof) after the move.

In response to detecting the target person's obstructed view of the projected visual information, the local computing device 110 of the vehicle can use data from the sensors 280, 285, and/or 290 to determine that the view of the target person to the projected visual information on that surface would not be obstructed if the visual information is projected from the projector 270 and/or the projector 275 (e.g., instead of the projector 265) given the relative position of the target person, the occupant 250, the surface, and the projector 270 and/or the projector 275. Accordingly, the local computing device 110 can trigger the projector 270 and/or the projector 275 to project the visual information onto the surface. In other words, the local computing device 110 can switch from using the projector 265 to project the visual information to using the projector 270 and/or the projector 275, in order to avoid the obstruction (e.g., the occupant 250) that is blocking or impairing the target person's view to the visual information when projected by the projector 265. Thus, the local computing device 110 can intelligently change which projector(s) is used to project visual information to avoid obstructions within the vehicle. In the previous example, since the projector 270 and the projector 275 have different positions than the projector 265 relative to the target person, the occupant 250 causing the obstruction, and the surface used to project the visual information, the change of projectors used to project the visual information can allow the local computing device 110 to avoid or circumvent the obstruction experienced when the visual information is projected from the projector 265.

In some examples, the avatar 215 can be projected on the surface of the top portion 210 of the dashboard 205 to help guide the target person entering the vehicle by providing the target person an indication (e.g., via the avatar 215) of where that target person should sit in the vehicle and/or how the target person should enter and sit in the vehicle. For example, the avatar 215 includes an arrow next to the avatar 215 pointed in a particular direction to indicate to a target person of the vehicle that the target person should move in the direction of the arrow next to the avatar 215. In FIG. 2, the avatar 215 is projected on the surface of the top portion 210 of the dashboard 205 but, in other examples, the avatar 215 may be projected on other surfaces of the vehicle and/or used to provide one or more passengers other information such as, for example, guiding a person in the vehicle when exiting the vehicle, alerting a target person in the vehicle of a personal object that the target person may be forgetting in the vehicle, alerting the target person in the vehicle of an event or another object in the vehicle, providing a visual message to the target person in the vehicle, showing the target person in the vehicle how to fasten a seatbelt, guiding the target person in the vehicle to perform a particular activity or to move to another location within the vehicle, and/or to provide any other information to one or more passengers of the vehicle.

In some cases, the avatar 215 may be projected by projector 275 on a surface of the top portion 210 of the dashboard 205 when a target person opens a passenger door (not illustrated) of the vehicle and begins to enter the vehicle. The avatar 215 may inform the target person how to enter the vehicle and/or where to sit within the vehicle (e.g., which seat to use). For example, motion of the avatar 215 may help instruct the target person entering the vehicle through the passenger door to sit in the passenger seat (not illustrated) next to (e.g., adjacent to) the steering wheel 245. The avatar projection may also be moved onto the seat that should be used by the target person entering the vehicle to further guide the target person to that seat. Other non-limiting example motions that can be performed by an avatar may include the avatar fastening a seat belt, the avatar placing a bag on a particular region of the vehicle, the avatar closing or opening a door of the vehicle, the avatar opening or closing a window, the avatar releasing a retracted cup holder, and/or any other motion and/or animation.

In some examples, verbal instructions may also be provided to the target person entering the vehicle and sitting in the passenger seat (and/or to any other passenger of the vehicle). For example, the vehicle may output verbal instructions for the target person using a speaker(s) in the vehicle. In the example described above, the verbal instructions may supplement the projection of the avatar 215 to provide audio information to the target person entering the vehicle in addition to the visual information (e.g., the avatar 215) provided to that target person. In other examples, the vehicle may output other audio information such as verbal instructions and/or audio information for another passenger(s) of the vehicle. In some cases, the other audio information can include verbal instructions. The verbal instructions may provide any information to any person on the vehicle, such as the target person entering the vehicle or any person in the vehicle, entering the vehicle, and/or exiting the vehicle. For example, in some cases, the vehicle may output verbal instructions to a target person entering the vehicle which state “please enter the vehicle and sit in the passenger seat as the avatar shows and fasten your seat belt.”

In some cases, the audio information can relate to a projection of visual information provided by a projector, such as projector 265, projector 270, and/or projector 275. For example, the vehicle can output audio information that is synchronized with certain projections of visual information and/or certain movements depicted by a projection of visual information. To illustrate, in some examples, the avatar 215 projected on the surface of the top portion 210 of the dashboard 205 may be depicted as performing a gesture where the avatar 215 points to a seat that a target person entering the vehicle should use to sit in the vehicle. As the avatar 215 depicts the gesture pointing to a seat, the vehicle can output audio information stating, for example, “take the seat shown by the avatar projected on the top portion of the dashboard.”

The side portion 220 of the dashboard 205 shown in FIG. 2 includes vents 225, a first projection 230, a second projection 235, and a patterned surface 240. The first projection 230 and the second projection 235 can be generated and/or projected by one or more of the projectors 265, 270, and/or 275 in the interior 200 of the vehicle. For example, the first projection 230 can be projected by the projector 270 if the projector 270 has an unobstructed view of the surface and area on which the first projection 230 is projected (and if the target person has an unobstructed view of that surface and area and/or the first projection 230 from the projector 270). Similarly, the second projection 235 can be projected by the projector 265 if the projector 265 has an unobstructed view of the surface and area on which the second projection 235 is projected (and if the target person has an unobstructed view of that surface and area and/or the second projection 235 from the projector 265). In this way, different projectors with different projection angles/positions can be leveraged to project visual information on surfaces and ensure that a target person's view to such projections is not obstructed.

Data from the sensors 280, 285, and/or 290 in the interior 200 of the vehicle can be used to identify locations and surfaces on the vehicle for projecting visual information, such as surfaces on the dashboard 205 for example, as well as locations and surfaces on which visual information (e.g., images, videos, visual animations, visual messages, light, etc.) should not be projected because such projections would likely not be visible or discernible to a target person(s) within the vehicle. For example, data from the sensors 280, 285, and/or 290 can be used to identify one or more surfaces in the interior 200 of the vehicle that are inadequate for projecting visual information because they have certain characteristics (e.g., patterns, colors, textures, shapes, sizes, irregularities, configurations, etc.) that make such surfaces poor candidates for projecting visual information. In some examples, a surface may be deemed a poor candidate for projecting visual information if the a size and/or shape of the surface cannot fit the visual information that the local computing device 110 of the vehicle intends to have projected onto a surface of the vehicle, if certain characteristics (e.g., color, pattern, texture, etc.) of the surface would not provide a threshold contrast with the visual information (e.g., given characteristics of the visual information such as color, texture, pattern, etc.) that would allow a person to discern the visual information from the surface (e.g., given the visual capabilities and/or characteristics of the human eye), if the surface is not continuous and the lack of surface continuity would prevent or limit a visibility (e.g., to the human eye) of at least a threshold amount of the visual information, and/or other any other reason.

For example, since the vents 225 and the patterned surface 240 in FIG. 2 include features that may not provide an adequate surface for projecting visual information, the vents 225 and the patterned surface 240 may be avoided when selecting a surface to project visual information. To illustrate, the vents 225 include holes or lines on which visual information cannot be projected (e.g., because the holes or lines in the vents 225 result in portions of the vents 225 lacking a surface on which visual information can be projected) and/or that can create inconsistencies, such as discontinuities, in any visual information projected on such vents 225. Moreover, the patterns on the patterned surface 240 may prevent a person from (or create difficulties for a person in) discerning visual information projected at least partly on the patterned surface 240, as the patterns on the patterned surface 240 may obfuscate portions of the visual information, reduce a contrast between the patterned surface 240 and the visual information, and/or otherwise increase a difficulty for a target person to discern between portions of the visual information projected and portions of the patterned surface 240 or otherwise conceal at least a portion of the visual information if at least part of the visual information is projected on an associated surface of the patterned surface 240.

Furthermore, projections may generally not be projected onto areas of the interior, such as the dashboard 205, that are blocked by objects, such as the steering wheel 245, from a perspective of a target person in the vehicle. For example, the local computing device 110 of the vehicle may determine that visual information should not be projected on areas of the dashboard 205 blocked by the steering wheel 245 from a perspective of a person who would be or is sitting in an area of the vehicle facing a portion of the steering wheel 245 that is blocking or would block the person's view to such areas of the dashboard 205. The steering wheel 245 may directly block the projection of visual information on a surface of such areas of the dashboard 205 by preventing light emitted by the projector (e.g., projector 265, projector 270, or projector 275) from reaching the surface(s) associated with such areas of the dashboard 205. For example, the steering wheel 245 may block a view of a person sitting in a seat of the vehicle facing the steering wheel 245 to certain areas of the dashboard 205 behind the steering wheel 245 (e.g., on a side of the steering wheel 245 opposite to a side of the steering wheel 245 facing the seat on which the person is sitting).

In some examples, data from different sensors (e.g., sensors 280, 285, and/or 290) can be combined to expand the amount of surface areas perceived and/or measured by the sensors of the vehicle (and/or depicted or represented by data from such sensors) and/or to provide redundant views and/or depictions/representations of certain areas of the vehicle (e.g., such that such areas are captured, depicted, and/or represented by data from one or more of the sensors). For example, data from a camera sensor(s) may be combined with data from another sensor(s), such as a LIDAR and/or a RADAR. By using data from a combination of sensors, the local computing device 110 of the vehicle may be able to more precisely evaluate a location/pose of objects or surfaces onto which visual information (e.g., images, videos, animations, messages, light patterns, etc.) may be projected, identify characteristics (e.g., color, texture, pattern, shape, size, illumination levels, etc.) of objects and/or surfaces in the vehicle, determine whether visual information (e.g., an image, a video, a visual message, a visual animation, a light pattern, etc.) projected onto a surface is projected onto a correct and/or selected/intended surface.

As previously noted, different sensors and/or projectors can be implemented to account for any potential obstructions (e.g., objects, persons, body parts, etc.) in the vehicle that may move and thereby block and/or impair the ability of one or more of the different projectors to project visual information onto a surface between the one or more of the different projectors and any potential obstructions, block and/or impair the ability of one or more of the different sensors to perceive a surface inside of the vehicle used to project visual information (e.g., on which visual information is projected) and/or identified as a candidate surface for projecting visual information, block a line of sight of one or more of the different sensors and/or projectors to a surface in the vehicle used to project visual information and/or identified as a candidate surface for projecting visual information, and/or block and/or impair a target person's view to a projection on a surface from the position of the projector 265, the projector 270, and/or the projector 275.

The local computing device 110 may also use data from one or more of the sensors 280, 285, and/or 290 to validate that the visual information projected onto a surface of the vehicle is visible and discernible to a target person in the vehicle. For example, the local computing device 110 may obtain sensor data depicting a particular surface on the vehicle and perform image processing (e.g., object detection, background and/or foreground detection, image quality detection, etc.) to determine whether the visual information projected onto the surface is visible and discernible to a target person in the vehicle. Surfaces onto which images are projected may be referred to as display areas or selected surfaces. Such selected surfaces may include various surfaces of the interior 200 of the vehicle. In some cases, such surfaces can also include surfaces of objects and/or people in the vehicle. For example, such surfaces can include a surface of the back of the occupant 250, the back of the head 255 of the occupant 250, a surface of the purse 260, etc.

In the example shown in FIG. 2, projector 265 may project seat belt image 250A onto a back portion of the occupant 250 or may project seat belt image 260A onto the purse 260. The arrowed lines attached to the back of the occupant 250 and the arrowed lines attached to projected image 250A indicate that, as the occupant 250 of the vehicle moves from left to right, that projected image 250A may be moved respectively to the left and right—staying positioned within and/or centered on the back of the occupant 250. LIDAR data from a LIDAR sensor may be used to identify precise locations of moving objects in the vehicle. This LIDAR data and potentially camera data may be used to identify where the back of the occupant 250 is located and/or the dimensions of the back of the occupant 250. In instances when the head 255 of the occupant 250 is not a surface that is selected as a display area, the projector 265 may avoid (e.g., based on an instruction from the local computing device 110) projecting visual information onto the head 255 of the occupant 250. Alternatively, when the head 255 is selected as a display area, visual information may be projected onto the head 255 of the occupant 250. This LIDAR and/or camera data may be evaluated to identify that visual information should not be projected onto dashboard areas that are blocked by the head 255 of the occupant 250 and/or any other objects.

In some examples, the systems and techniques described herein can be used to track motions of occupants of the vehicle or items that an occupant of the vehicle may pick up and move in the vehicle. For example, image 260A may be projected onto purse 260 when the occupant 250 moves purse 260 around in the vehicle. A person may move an object to a position where they may read text projected onto the object.

Projections 230 and 235 illustrate visual text that may be presented to (e.g., projected for) individuals sitting in the vehicle. Note that projection 230 informs such individuals that a vista point is coming up in one mile. At this moment, one of the individuals in the vehicle may provide input to the local computing device 110 of the vehicle to stop the vehicle at the vista point. Projection 235 asks the individuals in the vehicle if they “want to stop at a particular place?” Individuals within the vehicle or users of the vehicle may provide input by making a verbal statement, making selections via certain interface elements (e.g., physical and/or virtual) such as buttons and/or other input elements, providing input via a touch display, and/or touching virtual icons (e.g., projected selection boxes). Such user input could instruct the local computing device 110 of the vehicle to stop the vehicle at the particular place or skip stopping at the particular place.

In an instance when a user provides verbal commands, a processor of the AV control system may convert received audio speech information to computer data when identifying an instruction. When this user provides a virtual input, that user may touch a spot on the dashboard that corresponds to a yes or no selection box. Once the AV control system has an answer, the AV control system may perform an appropriate function. In instances when the AV control system receives no answer, the AV control system may make its own determination, for example, by assuming the answer is no or by assuming that the answer is yes based on some condition of the vehicle. For example, when the AV is low on energy or fuel (below a threshold level), and no answer is received regarding stopping at an upcoming charging or fueling station, the AV control system may assume that the AV should stop at the charging or fueling station.

While not illustrated in FIG. 2, avatars, messages, or other information may be projected onto a surface of the windshield 295 or a mirror image of a set of information may be projected onto the top dashboard surface 210 such that a reflection of that image may appear on a portion of windshield 295. In such an instance, the reflected image would have a correct orientation because the reflection of a mirrored image results in the image being presented with the correct orientation. Such reflections may be similar to a reflection in a windshield of a piece of white paper that has been placed on a black surface. Background or ambient lighting may also result in a processor making determination as to whether a certain surface should be selected as a display area, and/or the processor may change colors or sizes of projections based on this background or ambient lighting and possibly a set of projection rules.

In some cases, windows of the vehicle can include head-up displays (HUDs) and can be used to display information for persons in the vehicle. In some examples, the local computing device 110 can use data from the sensors 280, 285, and/or 290 to determine a visibility of any person in the vehicle to one or more windows of the vehicle, and can trigger a display of information at a particular window of the vehicle. For example, the local computing device 110 may determine that a person in the vehicle is looking at visual information presented on a window next to a right passenger back seat. If the local computing device 110 determines that a view of the person to that window has become obstructed (e.g., because of an object or a person's body part) has moved within a viewing path from the person to the window, the local computing device 110 can trigger a switch from presenting the visual information on that window to presenting the visual information on a different window or a switch to continue presenting the visual information using a projector by projecting the visual information on a surface of the vehicle as previously described.

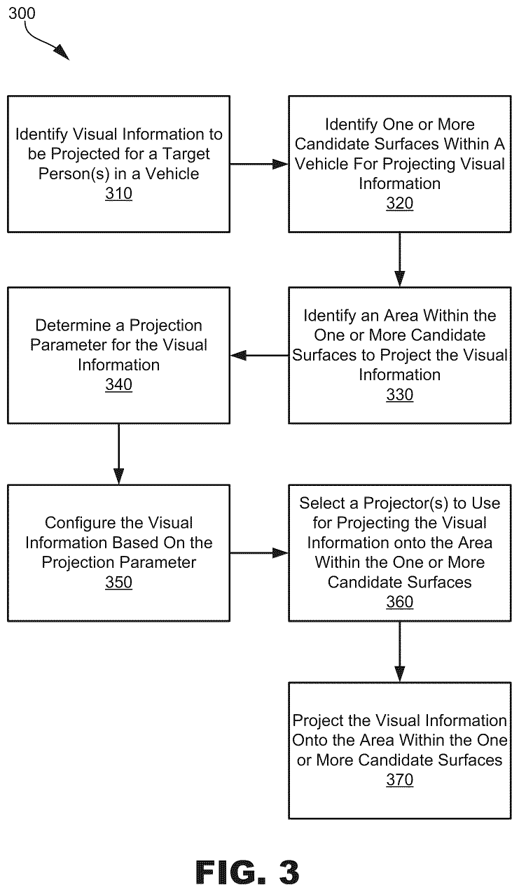

FIG. 3 illustrates an example process 300 for projecting visual information for passengers of an autonomous vehicle (e.g., AV 102), in accordance with some examples of the present disclosure. At block 310, the process 300 can include identifying visual information to be projected on a surface of the vehicle for a target person(s) in the vehicle. The visual information can include any visual information and/or type of visual information such as, for example and without limitation, an image, a video, an avatar, a visual message, a light pattern, an animation, a shape, a symbol, and/or any visual information.

Identifying the visual information can include determining a content to be conveyed by the visual information and/or one or more attributes (e.g., color, dimensions, texture, configuration, etc.) of the visual information. For example, the local computing device 110 of the vehicle can determine what content to convey in the visual information based on a context of the vehicle and/or a target person(s). To illustrate, if the context includes a target person entering the vehicle, the local computing device 110 may determine that the visual information should convey information and/or instructions for how to enter the vehicle, where to sit within the vehicle (e.g., what seat to take), how to secure a seat belt, etc.

The local computing device 110 can then determine what visual information to present in order to convey such information and/or how to convey such information through a projection of visual information. For example, the local computing device 110 may to convey such information using an avatar (with or without animations), a visual message (e.g., visual text instructions), a shape(s) (e.g., a symbol(s), an arrow(s), a representation of a seat or any other object, etc.), a video, a light pattern (e.g., flashing light, a light pattern depicting a light animation, a pattern of light colors, etc.), and/or any other type or mode of visual information.

Moreover, the local computing device 110 can determine the one or more attributes of the visual information such that the one or more attributes are used to convey certain information and/or any details associated with the visual information to be projected. For example, the color red can be used with the visual information to convey a warning, an error, an alert, a severity level of something associated with the visual information, an urgency associated with the visual information, etc.; the color green can be used to convey an acceptance or validity of something, etc.; the size of the visual information can be used to convey one or more details about the visual information such as, for example, an urgency, a severity, etc.; a shape of the visual information can be used to convey certain details associated with the visual information; etc.

In some cases, the attributes of the visual information can also be selected to increase the ability of target users to see/perceive and/or discern the visual information. For example, certain attributes (e.g., color, dimensions, shape, etc.) can be selected for the visual information to increase the likelihood that a target person in the vehicle will see the visual information. As another example, certain attributes can be selected for the visual information to increase the likelihood that the visual information will be discernible from a surface on which the visual information is projected. To illustrate, if a surface on the vehicle potentially used to project the visual information is black, a specific color(s) can be used for the visual information to ensure that the visual information will be discernible to the human eye from the black surface on which the visual information is projected. The specific color(s) can include a color that provides a certain contrast with the color of the surface on which the visual information will or may be projected. In the previous example, if the surface is or is anticipated to be black, the color selected for the visual information can include white or a light color that will provide a contrast to the black surface.

As another example, the dimensions of the visual information can be selected to ensure that the visual information will fit (e.g., will be fully contained within or will allow a threshold amount of the visual information to be contained within) within a specific surface and/or a specific type of surface. For example, if the local computing device 110 intends to project the visual information onto a person's hand or onto a door handle, the local computing device 110 can configure the dimensions of the visual information such that the visual information can be projected on and can fit within a hand or a door handle. As yet another example, a pattern(s) of the visual information can be selected to ensure that the visual information will be discernible to the human eye when projected onto a particular surface(s) and/or a particular surface pattern(s). To illustrate, if the local computing device 110 intends to project (or wants to ensure that the visual information can be projected on a surface pattern and will be discernible to the human eye when projected on such a surface pattern) the visual information onto a surface that includes a pattern of white and black areas, the local computing device 110 may select a pattern for the visual information such that portions of the visual information that will be projected on white areas will be black or a color that is a certain amount darker than white which will provide a contrast with the white, and portions of the visual information that will be projected on black areas will be white or a color that is a certain amount lighter than black which will provide a contrast with the black.

In some cases, identifying the visual information can include identifying an avatar to provide to a target person in the vehicle, entering the vehicle, or exiting the vehicle. For example, an avatar may be used to instruct a target person to sit in a particular seat in the vehicle. In some cases, an avatar may additionally or alternatively be used to remind or inform a target person to fasten their seatbelts or perform other actions.

In some examples, the visual information (e.g., messages and/or other types of visual information), the content of the visual information, and/or the attributes of the visual information to be provided to a target person (e.g., to be projected for the target person) can in some cases be at least partly based on user preferences. For example, if a user profile available to the local computing device 110 of the vehicle indicates that a target person is color blind, the local computing device 110 can avoid using color to convey information in visual information intended for that target person. As another example, if a user preference indicates that the vehicle should be recharged, if possible, before the vehicle's charge reaches a threshold level, the local computing device 110 of the vehicle may select to project visual information for a target person associated with such user preferences to indicate that a charge of the vehicle has reached (or will reach after a certain driving distance and/or time) the threshold level. Such visual information warning the target person that the vehicle's charge has reached or will reach the threshold level may allow the target person to provide a response by speaking, pressing a button (physical or virtual), making a gesture, providing an input (e.g., via a device, a virtual interface, a touch screen, and/or any other input means).

As yet another example, if the user profile indicates that the target person is far sighted, the local computing device 110 can increase the size of visual information provided to that target person. The local computing device 110 can also use the user preferences when identifying and selecting a surface on which to project the visual information. For example, if the user profile indicates that the target person is far sighted, the local computing device 110 can select surfaces on which to project the visual information that are within a range of distances from that target person.

At block 320, the process 300 can include identifying one or more candidate surfaces within a vehicle (e.g., AV 102) for projecting visual information (e.g., on which to project visual information). For example, the local computing device 110 of the vehicle can obtain sensor data and use the sensor data to determine a candidate surface on which to project visual information. The sensor data may include data collected from one or more sensors (e.g., sensor systems 104, 106, and/or 108 shown in FIG. 1 and/or sensors 280, 285, and/or 290 shown in FIG. 2) in an interior (e.g., interior 200 shown in FIG. 2) of the vehicle. The one or more sensors can include, for example and without limitation, a camera sensor, a LIDAR sensor, a RADAR sensor, and/or any other type of sensor(s) and/or combination thereof. In some examples, the one or more candidate surfaces can include, without limitation, a surface of a dashboard of the vehicle, a surface of a seat of the vehicle, a surface of a side panel of the vehicle, a window of the vehicle, a surface of a steering wheel of the vehicle, a ceiling of an interior of the vehicle, a body part of an occupant of the vehicle, a surface of an object within the vehicle (e.g., a purse, a device, a bag, an article of clothing, and/or any other surface.

In some examples, identifying one or more candidate surfaces can include identifying, based on the sensor data, a set of candidate surfaces and the locations of the set of candidate surfaces relative to a position of one or more projectors in the vehicle and/or relative to a respective position of each occupant of the vehicle. For example, the local computing device 110 of the vehicle can use the sensor data to identify a set of candidate surfaces within the vehicle and characteristics of the set of candidate surfaces such as, for example, their respective locations within the vehicle, their respective colors, their respective patterns (if any), their respective dimensions, whether they have any surface discontinuities (e.g., holes or openings, surface gaps, etc.), and/or any other characteristics of the set of surfaces. In some cases, identifying one or more candidate surfaces can include identifying any objects, occupants, occlusions/obstructions, movements, and/or conditions within the vehicle (e.g., in the interior of the vehicle) as discussed above with respect to FIG. 2.

For example, the local computing device 110 of the vehicle can use the sensor data to determine the position of each occupant of the vehicle relative to the location of the one or more candidate surfaces, determine a viewing path for a target person(s) in the vehicle to see the one or more candidate surfaces, determine a projection path from a projector(s) on the vehicle to the one or more candidate surfaces, determine whether there are any objects that may obstruct/occlude any visual projections on the one or more candidate surfaces (e.g., whether there are any objects or obstructions within the viewing path of the target person(s) to the one or more candidate surfaces), determine an amount of light illuminating the one or more surfaces (e.g., lighting conditions of the one or more candidate surfaces), and/or determine whether any potential obstructions (e.g., objects, occupants, body parts, etc.) have moved within a projection path from a projector(s) in the vehicle to the one or more candidate surfaces.

As previously noted, identifying the one or more candidate surfaces can include identifying a set of surfaces in an interior of the vehicle and one or more characteristics of the set of surfaces. In some examples, the local computing device 110 of the vehicle can select the one or more candidate surfaces from the set of surfaces based on the characteristics of the set of surfaces and a determination regarding whether there are any obstructions that may block or impair a target person(s) view of the set of surfaces given the respective location of a target person(s), the respective location of one or more projectors within the vehicle, and the respective locations of the set of surfaces relative to the respective locations of the target person(s), the one or more projectors, and any objects (e.g., including any potential obstructions/occlusions) in the vehicle. The local computing device 110 can use the detected characteristics of the set of surfaces to identify which of the set of surfaces are adequate surfaces for projecting visual information.

In some cases, the one or more surfaces can be identified based on one or more rules for selecting surfaces on which to project visual information. The one or more rules can include rules defining acceptable or suitable surface colors for specific colors of visual information, acceptable or suitable surface patterns for specific patterns of visual information, acceptable or suitable surface textures for specific visual information attributes, acceptable or suitable surface shapes for specific configurations of visual information, acceptable or suitable surface lighting conditions for specific configurations of visual information, and/or any other mappings of acceptable or suitable surface attributes to visual information attributes.

At block 330, the process 300 can include identifying an area within the one or more candidate surfaces to project the visual information. The local computing device 110 can use sensor data to determine the area to project the visual information. For example, the local computing device 110 may receive sensor data depicting areas within the one or more candidate surfaces of the vehicle, and may determine an area within the one or more candidate surfaces to project the visual information. In some cases, the local computing device 110 can select the area based on a determination that the visual information would fit within a surface of the area. In addition or alternatively, the local computing device 110 can select the area based on a determination that the visual information would be visible and discernible to a target person within the vehicle. The local computing device 110 can determine whether the visual information would be visible and discernible to the target person if projected onto the area based on attributes of the area and the visual information such as, for example and without limitation, a color of the surface of the area, a color of the visual information, a pattern of the surface of the area, a pattern of the visual information, dimensions of the area and the visual information, a shape of the visual information and a shape of the area, lighting conditions around the area, and/or one or more other configuration parameters of the area, the surface of the area, and/or the visual information.

In addition, the local computing device 110 can determine whether the visual information would be visible and discernible to the target person if projected onto the area based on a determination whether a view of the target person to the area is blocked, obstructed, and/or impaired by one or more obstructions such as, for example, an object, a person, a body part of a person, an animal in the vehicle, and/or anything else. The local computing device 110 can determine whether the view of the target person to visual information projected on a surface of the area is blocked, obstructed, and/or impaired based on a location of the area relative to a position of the target person and a position of one or more projectors in the vehicle for projecting the visual information, and a location of any potential obstruction (e.g., an object, an occupant, a body part, an animal, etc.), if any, relative to the location of the area and the position of the target person within the vehicle. The relative location of any potential obstruction can be used to determine whether there is anything within a viewing path from the target person to the area on which the visual information would be projected that could potentially block, obstruct, and/or impair a visibility of the target person to the area or, more specifically, to the visual information if projected onto the area.

At block 340, the process 300 can include determining a projection parameter for the visual information. Non-limiting illustrative examples of projection parameters can include a color parameter, a projection brightness parameter, a projection size, a projection pattern parameter, a projection timing parameter (e.g., when to project the visual information, how long to project the visual information, when to stop projecting the visual information, etc.), a supplemental information parameter (e.g., a parameter specifying whether other information modalities should be used for information provided in addition to the visual information such as audio or any other modality), a projection shape, and motion parameter. A color parameter can identify one or more colors of the visual information. A brightness parameter may specify brightness levels of the visual information. The brightness of the visual indicator may be increased when ambient lighting is brighter than a brightness threshold (e.g., during a sunny or partly cloudy day, when transiting a scene with certain illumination and/or illumination sources, etc.) and/or decreased when ambient lighting is dimmer than a dimness threshold (e.g., during the night, during a cloudy day, during a storm, etc.). The projection pattern parameter can specify one or more patterns for the visual information. The motion parameter can specify an amount and/or type of motion to implement with the visual information (e.g., whether the visual information should include motion and, if so, how much and/or what type of motion), a motion of the area and associated surface on which the visual information will be projected, and/or an amount and/or type of motion that should be implemented with the visual information to align with or counter any motion of the area and associated surface on which the visual information will be projected.

In some examples, the process 300 may include identifying that white text should be projected onto a darker (e.g., black or another color with a threshold darkness) display area (e.g., projection surface) or that black text should be projected onto a lighter (e.g., white or another lighter color) display area. Since contrasting colors are more visible than non-contrasting colors, the local computing device 110 of the vehicle may use contrasting colors when updating visual information.

At block 350, the process 300 can include configuring the visual information based on the projection parameter. For example, if the projection parameter includes color parameter specifying a particular color for the visual information and a size parameter specifying a size of the visual information, the local computing device 110 can configure the visual information to implement the particular color specified by the color parameter and the size specified by the size parameter. In some cases, configuring the visual information can include updating one or more attributes of the visual information. For example, if the visual information identified at block 310 includes a first size and a first color and the projection parameter includes a color parameter that specifies a second color and a size parameter that specifies a second size, the local computing device 110 can update the visual information to implement the second size and the second color. In instances when a selected display area includes multiple colors, the visual information projected may include different contrasting colors. For example, when a display area includes a white surface and a black surface, portions of the visual information projected onto the white surface may be darker in color than the white surface, and visual information projected onto the black surface may be lighter in color than the black surface.

In some cases, a set of projection rules can be used when identifying a configuration of the visual information and/or the display area for the visual information. For example, when one or more projection rules indicate that surfaces that include patterns, holes, openings, or features are not suitable for viewing projected visual information (e.g., the visual information when projected on such surfaces would have less than a threshold visibility and/or less than a threshold likelihood that the visual information will be discernable to the human eye), such locations may be identified as locations where visual information should not be used as display surfaces for projecting visual information. For example, in some cases, areas with vents, certain patterns, and/or certain dimensions may be indicated as unsuitable display areas and/or otherwise avoided.

At block 360, the process 300 can include selecting a projector(s) to use for projecting the visual information onto the area within the one or more candidate surfaces. For example, if there are multiple projectors (e.g., projectors 265, 270, and/or 275) inside of the vehicle (e.g., interior 200) available for projecting visual information, the local computing device 110 can select one or more of the multiple projectors to project the visual information. In some cases, the local computing device 110 can select the one or more projectors based on a respective location and pose of each projector relative to the area within the one or more surfaces and/or relative to a viewing perspective of a target person(s) (e.g., which is based on a position of the target person(s)). For example, the local computing device 110 can select a specific projector to project the visual information based on the projection angle onto the area within the one or more candidate surfaces given a position of that projector.

In some cases, multiple projectors can be used to project the visual information. For example, different projectors can be used to project different portions of the visual information. In some cases, different projectors can project different visual information to generate a composite rendering of visual information.

At block 370, the process 300 can include projecting the visual information onto the area within the one or more candidate surfaces using the selected projector(s). For example, the local computing device 110 of the vehicle can trigger the projector(s) to project the visual information onto the area within the one or more surfaces. In some cases, the local computing device 110 can send, to the projector(s), an instruction or command configured to trigger the projector(s) to project the visual information. The instruction or command can include, for example, the visual information to be projected, one or more parameters identifying the location of the area onto which the visual information is to be projected, and/or any projection parameters. Such projection parameters can include, for example and without limitation, a timing parameter (e.g., when to project the visual information, how long to project the visual information, when to stop projecting the visual information, etc.), a projection angle, a pattern of projection (e.g., a flashing pattern, a static pattern, a pattern of color changes, an animation pattern, etc.), a projection motion (e.g., whether to move, how to move, when to move, when to stop moving, etc.), and/or any other projection parameter.

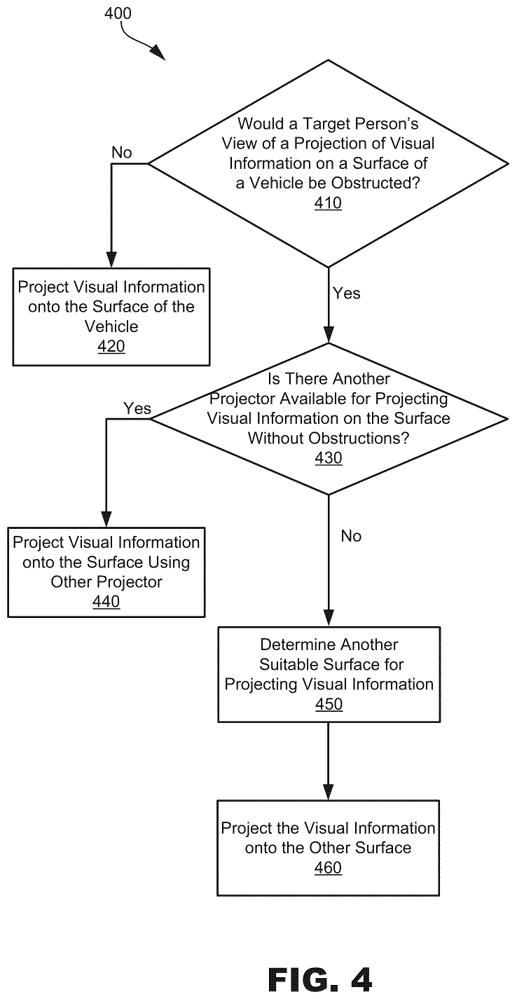

FIG. 4 illustrates an example process 400 for determining where to project visual information for a target person based on a determination that a target person's view to a projection of visual information is or is not obstructed. At block 410, the process 400 can include determining whether a target person's view of a projection of visual information on a surface of a vehicle would be obstructed (e.g., blocked, occluded, impaired, etc.).

For example, the process 400 can include determining, based on sensor data, whether there are any obstructions (e.g., an object, a person, a body part, an animal, an obstacle, etc.) in a target person's viewing path to the surface in the vehicle where visual information is being or will be projected, or a surface being considered by a local computing device 110 of the vehicle as a candidate surface for projecting visual information within the vehicle. In some cases, the local computing device 110 can use sensor data to determine a FOV of the target person, determine whether the surface of the vehicle where the visual information would be projected is within the FOV of the target person, and determine whether anything located within the target person's FOV would obstruct the target person's ability to see and/or perceive a projection of visual information on the surface given the pose and/or viewing perspective of the target person.

The target person can include an occupant in the vehicle, entering the vehicle, or exiting the vehicle. Moreover, the local computing device 110 can determine whether the target person's view of a projection of visual information on a surface of the vehicle would be obstructed based on sensor data captured by one or more sensors (e.g., sensor systems 104, 106, 108; or sensors 280, 285, 290) in an interior (e.g., interior 200) of the vehicle. For example, the local computing device 110 can use sensor data (e.g., from one or more sensors) depicting and/or describing an area within the interior of the vehicle that includes the surface on which the visual information would be projected and a viewing path of the target person to the surface (e.g., to the projection of visual information) to detect any obstructions (e.g., an object, a person, a body part (e.g., a hand, an arm, a head, a back, a shoulder, a foot, etc.), an obstacle, an animal, and/or any other type of obstacle) within the FOV of the target person and/or within a viewing path of the target person to the surface on which the visual information would be projected. The sensor data can include, for example and without limitation, image data, LIDAR data, RADAR data, inertial measurements, depth measurements (and/or TOF measurements), and/or any other type of sensor data.

In some cases, the local computing device 110 of the vehicle can determine whether an obstacle(s) in the vehicle will likely (or will likely not) obstruct (e.g., block, occlude, impair, etc.) a view of the target person to a projection of visual information on the surface based on a pose of the target person, an estimated FOV of the target person, and/or a position of the eyes of the target person (e.g., an eye gaze of the target person). The local computing device 110 can determine the pose of the target person, the estimated FOV of the target person, and/or the position of the eyes of the target person based on sensor data such as, for example, image data, LIDAR data, RADAR data, inertial measurements, depth measurements, ultrasound sensor data, and/or any other type of sensor data.

For example, the local computing device 110 can use image data from one or more camera sensors to perform eye gaze detection and/or eye tracking. The local computing device 110 can use the eye gaze and/or eye tracking of the target person to determine whether the target person is looking at the surface and/or any potential obstructions, and/or to determine whether the eyes of the target person are positioned to see the surface and/or any potential obstructions. The local computing device 110 can use the eye gaze detection and/or eye tracking to determine whether the target user is likely looking at the surface where the visual information may be projected and/or whether the target is likely looking at any obstructions (e.g., an object, person, body part, animal, an obstacle, etc.). The local computing device 110 can determine a pose of the target person and/or a FOV of the target person based on sensor data. In some examples, the local computing device 110 can use the estimated pose of the target person to determine the FOV of the target person. In some cases, the local computing device 110 can use the estimated location of the surface and the estimated FOV of the target person to determine whether the surface on which the visual information may be projected is within the FOV of the target person. Similarly, the local computing device 110 can determine whether any obstructions are within the FOV of the target person, and use the FOV of the target person and the position (e.g., location and pose) of any obstructions within the FOV of the target person to determine whether there are any obstructions that would obstruct (e.g., block, occlude, impair) a view of the target person to the surface on which visual information may be projected.

As previously mentioned, the local computing device 110 can use sensor data to determine the pose and FOV of the target person, determine the position of any projectors in the vehicle relative to the surface and/or the target person, detect any obstructions within the FOV of the target person and/or within a viewing path from the target person to the surface, and/or determine whether there are any obstructions in the vehicle that may obstruct the target person's view of any visual information projected on the surface. In some cases, such sensor data can include, for example and without limitation, image data depicting the target person (and, in some cases, an area around the target person); LIDAR data depicting the target person and/or an area around the target person (e.g., including any items within a viewing path of the target person to the surface); RADAR data depicting and/or describing a range (distance), altitude, direction of movement, speed, and/or angle of the target person (relative to the RADAR associated with the RADAR data and/or the surface), any objects within a FOV of the target person (e.g., relative to the target person, the RADAR, and/or the surface), and/or the surface (e.g., relative to the target person, the RADAR, and/or any objects within a FOV of the target person); depth measurements from a TOF sensor depicting and/or describing a depth (e.g., proximity or distance) of the target person relative to the TOF sensor (and/or the surface) and/or a depth of the surface relative to the TOF sensor and/or the target person; inertial measurements describing any motion of the target person, the surface on which visual information would be projected, and/or any items within a FOV of the target person and/or within a viewing path of the target person to the surface from a perspective of the target person's position (and/or frame of reference); and/or ultrasound sensor data depicting and/or describing a range (distance), altitude, direction of movement, speed, and/or angle of the target person (relative to the ultrasound sensor and/or the surface), any objects within a FOV of the target person (e.g., relative to the target person, the ultrasound sensor, and/or the surface), and/or the surface (e.g., relative to the target person, the ultrasound sensor, and/or any objects within a FOV of the target person.

Non-limiting illustrative examples of obstructions that may obstruct (e.g., block, occlude, impair, etc.) a projection of visual information on a surface can include a body part (e.g., a hand, an arm, a head, a foot, a shoulder, a back, another body part of a person, etc.), an animal in the vehicle (e.g., a cat or dog in the vehicle, etc.), an occupant of the vehicle, an object (e.g., a device, a piece of clothing or clothing apparel, a seat (e.g., a headrest, a seat back, etc.), a steering wheel, etc.) in the vehicle, and/or any other obstacles. In certain instances, an obstruction may prevent (e.g., obstruct) a projection from reaching a location within the vehicle, such as a dashboard in the vehicle. For example, if an obstacle is located between a projector in the vehicle (e.g., used to project the visual information) and the dashboard location, light of the projection may fall on the obstacle and not the dashboard location. As further described herein, if the local computing device 110 determines that a view of the target person to a surface is obstructed, the process 400 may select another display area (e.g., another surface) to ensure that the target person can see the visual information that a projector projects onto such display area.

If the target person's view of the projection of visual information on the surface would not be obstructed, at block 420 the process 400 can include projecting the visual information onto the surface. For example, the local computing device 110 can send an instruction/command to a projector in the vehicle to trigger (e.g., configured to trigger) the projector to project the visual information onto the surface.

If the target person's view of the projection of visual information on the surface would be obstructed, at block 430 the process 400 can include determining whether there is another projector in the vehicle available for projecting the visual information onto the surface without obstructions to a view of the target person to the visual information. In some examples, determining whether there is another projector available for projecting the visual information on the surface can include determining whether a view of the target person to the visual information, when projected using the other projector from the other projector's perspective/position, would be obstructed. For example, the local computing device 110 can use sensor data to determine a projection path (e.g., angle, distance, height/altitude, direction, etc.) of the other projector to the surface and determine, based on the projection path and a pose of the target person, whether a view of the target person to the visual information projected by the other projector onto the surface would be obstructed.

If there is another projector available for projecting the visual information onto the surface without obstructions to the view of the target person to the visual information on the surface, at block 440 the process 400 can include projecting the visual information onto the surface using the other projector. On the other hand, if there is not another projector available for projecting the visual information onto the surface without obstructions to the view of the target person to the visual information on the surface, at block 450 the process 400 can include determining another surface for projecting the visual information. Determining another surface for projecting the visual information can include identifying another surface that is suitable for projecting the visual information.

In some examples, identifying another suitable surface for projecting the visual information can include determining whether there is a different surface on which the visual information can be projected without obstructions of a view of the target person to the projected visual information on the different surface, as previously explained. In some cases, identifying another suitable surface can include verifying that the visual information would be visible and discernible to the target person if projected onto the different surface. Such verification can be made based on characteristics (e.g., colors, patterns, textures, dimensions, illumination, etc.) of the different surface and the visual information, as previously explained. The characteristics of the different surface and the visual information can be determined based on sensor data such as, for example, image data, LIDAR data, RADAR data, ultrasound sensor data, inertial measurements, depth measurements, and/or any other type of sensor data.

A surface can be deemed to be a suitable surface for projecting the visual information based on a determination that the visual information, if projected on such surface, would be visible and discernible to the target person. The local computing device 110 can determine whether the visual information, if projected onto such surface, would be visible and discernible based on a FOV of the target person with relation to that surface, and a comparison of characteristics (e.g., colors, textures, patterns, dimensions, illumination, etc.) of the surface and the visual information, as previously described.

After determining another suitable surface for projecting the visual information, at block 460, the process 400 can include projecting (e.g., via a projector on the vehicle) the visual information onto the surface identified at block 450.

In some cases, over the span of a period of time, an obstruction that previously obstructed a view of the target person to a particular surface (and thus to visual information projected onto that surface) may no longer obstruct the target person's view because the target person and/or the obstruction has/have moved. In such cases, the local computing device 110 can trigger a projection (e.g., via a selected projector on the vehicle) of the visual information onto that surface even though the surface was previously determined to be unsuitable for projecting the visual information based on a determination that the obstruction was obstructing a view of the target person to that surface (and thus to visual information projected onto that surface). In some cases, one or more of the blocks in FIG. 4 may be performed in combination with one or more of the blocks in FIG. 3.

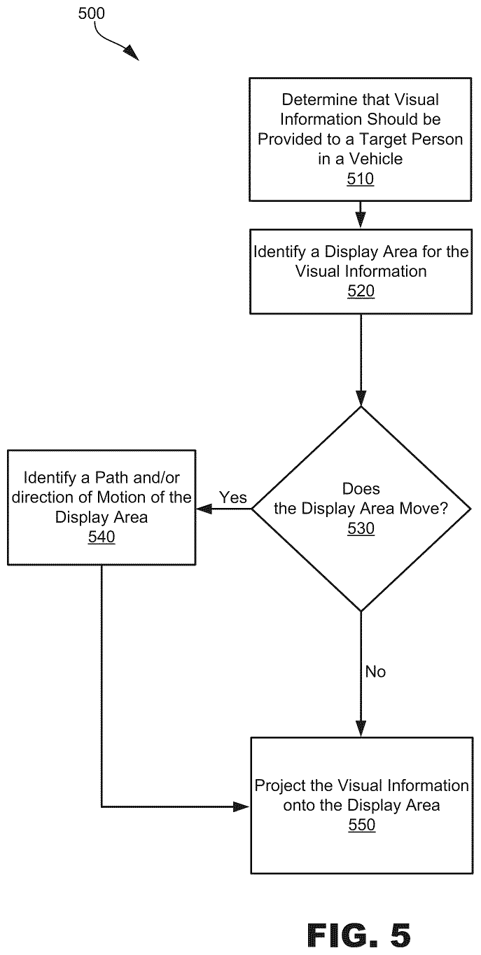

FIG. 5 illustrates an example process 500 for projecting visual information on an identified display area (e.g., a vehicle surface). At block 510, the process 500 can include determining that visual information should be provided to a target person in a vehicle (e.g., AV 102). At block 520, the process 500 can include identifying a display area for the visual information. The display area can include a surface within the vehicle. The display area can include a surface within an interior (e.g., interior 200) of the vehicle. Moreover, the display area can be identified based on a determination that a view of the target person to the display area (and thus to visual information projected on the display area) is not obstructed and that the display area provides a suitable surface for projecting visual information. The display area can be determined to provide a suitable surface based on a determination that the visual information would be visible and discernible to the target person if projected onto the display area. In some examples, the local computing device 110 can determine that the visual information, if projected onto the display area, would be visible and discernible to the target person based on a FOV of the target person, the location of the display area, and a comparison of characteristics (e.g., colors, textures, patterns, dimensions, illumination, etc.) of the display area and the visual information.

At block 530, the process 500 can include determining whether the display area move or is mobile. In other words, the local computing device 110 can determine whether the display area is static (relative to the vehicle) or otherwise is/can move (relative to the vehicle). For example, if the display area is a hand of a passenger of the vehicle, the local computing device 110 can determine that the display area (e.g., the hand) moves or can move during a projection of visual information onto it. On the other hand, if the display area is a surface on the dashboard of the vehicle, the local computing device 110 can determine that the display area is and will remain static relative to the vehicle.

If the local computing device 110 determines that the display area does not move or is not likely to move (e.g., is static relative to the vehicle), the process 500 can proceed to block 550. At block 550, the process 500 can include projecting the visual information onto the display area. For example, the local computing device 110 can send instructions/commands to a projector in the vehicle to project the visual information onto the display area. The instructions/commands can be configured to trigger the projector to project the visual information onto the display area. In some examples, the instructions/commands can include the visual information to be projected and an indication of the location of the display area, which the projector can use to know where to project (e.g., where to aim/direct the projection) the visual information.

In some cases, the instructions/commands can additionally include one or more projection parameters. The one or more projection parameters can include, for example, a timing parameter specifying when to initiate the projection, how long to project the visual information, and/or when to stop the projection; a projection configuration parameter specifying one or more dimensions of the projected visual information, an angle, orientation, and/or direction of projection informing the projector the angle, orientation, and/or direction in which the visual information should be projected and/or should appear in the display area; a preference parameter specifying any user preferences for visual information projections, and/or any other projection parameter. The one or more projection parameters can optionally include an animation parameter specifying any motion of the visual information when projected onto the display area. The motion of the visual information can describe how the visual information should move (e.g., a speed of movement, a direction of movement, a range of movement, an angle of movement, a path of motion, a timing of the movement, and/or any other motion parameter).

At block 540, the process 500 can include identifying a path and/or direction of motion of the display area. For example, if the display area is currently in motion, the local computing device 110 can track its movement and predict its trajectory (e.g., its path and direction) of movement. If the display area is not currently in motion but is expected to move, the local computing device 110 can estimate its expected path and/or direction of movement. For example, the local computing device 110 can use sensor data and information about the display area to predict a path and direction of motion of the display area. In some cases, the local computing device 110 can additionally use historical and/or statistical information to predict a path and direction of motion of the display area.

For example, if the display area is a car seat that is currently static but is expected to move when an occupant of the vehicle adjusts the seat, the local computing device 110 can review historical and/or statistical information describing the motion of the seat in previous occasions, and predict a path and direction of movement based on the description of motion of the seat in previous occasions. In some cases, when predicting the path and direction of the seat, the local computing device 110 can model a range of motions of the seat and predict a particular path and direction of motion based on the modeled range of motions. In some examples, the local computing device 110 can model (e.g., based on historical and/or statistical data) a motion of the seat when the seat is adjusted by a particular occupant of the vehicle, and predict the path and direction of motion of the seat based on the modeled motion of the seat when adjusted by that occupant. This way, the local computing device 110 can tailor its prediction of the path and direction of the seat to motion caused by a particular occupant as determined from previous adjustments of the seat by that occupant.

At block 550, the process 500 can include projecting the visual information onto the display area via a projector on the vehicle. When instructing a projector to project the visual information, the local computing device 110 can take into account the path and/or direction of motion of the display area. The local computing device 110 can take the path and/or direction of motion into account to ensure its instructions to the projector configured to trigger the projector to project the visual information onto the display area can include an indication of how the visual information should be projected in order to ensure that the visual information will remain within one or more boundaries of the display area even while the display area moves. The indication of how the visual information should be projected can include an indication of one or more dimensions (e.g., a size, a shape, a depth, a length, a width, a height, etc.) of the visual information (e.g., relative to the display area and/or absolute dimensions) when the visual information is projected (e.g., at one or more points in time during the projection), how the visual information should move when projected (e.g., a direction, a trajectory, a speed, a motion pattern, etc.) in order to remain within the display area when the display area moves, whether one or more attributes (e.g., dimensions, motion, orientation, angle of projection, etc.) of the visual information should be modified during the projection as a result of any movement of the display area, and/or any other information about the projection of the visual information.

For example, the local computing device 110 can determine whether any aspects of the visual information and/or the projection should be modified during the projection to ensure the visual information remains within the display area even while the display area moves. To illustrate, the local computing device 110 can determine changes in the speed and/or direction of movement of the projection (e.g., of the visual information) to ensure that the visual information remains within and/or aligned with the display area when the display area moves. As another example, the local computing device 110 can determine that a dimension(s) of the visual information, an orientation/angle of the visual information, and/or a projection parameter (e.g., a projection angle, a projection distance, a projection height, a projection direction, etc.) should change during the projection to ensure that the visual information remains within the display area, a projector used to project the visual information onto the surface has and/or maintains a line-of-sight to the display area such that the projection from the projector is not obstructed, and/or that a view of the target person to the visual information projected onto the display area remains free of obstructions that may block, impair, and/or occlude a visibility of the visual information on the display area.

In some examples when the visual information moves (e.g., because the visual information is animated and/or otherwise configured to move), a size of the projection of the visual information may be identified and implemented to ensure that the moving visual information stays within the display area as the visual information moves (and as the display area moves if the display area is determined to move at block 530). In an instance when the display area is moving, the movement of the display area may be tracked such that the visual information can be projected onto the moving display area and remains within the display area.

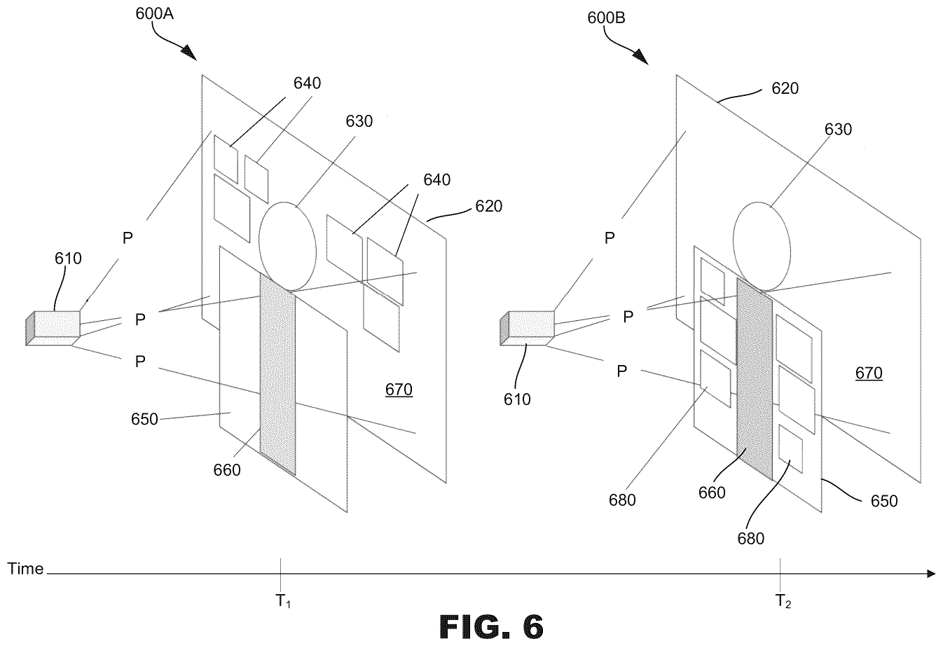

FIG. 6 illustrates different example depictions of a projector projecting visual information (e.g., an image, a video, a visual text message, an animation, a light pattern, emitted light, etc.) onto surfaces within a vehicle (e.g., AV 102) at different moments in time. In this example, the different depictions include a first depiction 600A that shows a projector 610 at time t₁ projecting visual information 640 onto a surface 620 of the vehicle. The projector 610 is configured to project visual information onto different locations within the vehicle along lines labeled as “P” in FIG. 6 and/or has a field-of-coverage that allows the projector 610 to project visual information onto any of the different locations along the lines labeled as “P”. The depiction 600A includes the vehicle surface 620, a vehicle occupant 630, and the visual information 640 projected onto surface 620 at time t₁.

The depiction 600A includes a seat 650 within the vehicle used by the occupant 630 to sit in. The seat 650 includes an area 660 that is not suited for projecting visual information onto and/or that does not have a suitable surface for projecting visual information onto it. For example, area 660 may include an unsuitable surface area for projecting visual information because a material of the surface of area 660 cannot be used to display the visual information 640 and/or because one or more attributes (e.g., color, texture, pattern, dimensions, etc.) of the surface of area 660 would prevent the visual information 640 from being visible or discernible to a target person in the vehicle if the visual information 640 is projected onto the surface of area 660. For example, a color, pattern, and/or texture of the surface of area 660 may obfuscate the visual information 640 given the color, pattern, and/or texture of the visual information 640.

Area 670 is an area of the vehicle surface 620 on which the visual information 640 should not be projected onto because occupant 630 and the seat 650 are positioned within a projection path of the visual information 640 (e.g., within a path between projector 610 and the area 670), and would thus obstruct a view of a target person to any projections of the visual information 640 from projector 610 onto the area 670.

In the depiction 600A, the projection of visual information 640 avoids an obstruction created by the seat 650. In other words, the projection of visual information 640 avoids the area 670 because the seat 650 would obstruct a view of a target person in the vehicle to the area 670, thus preventing the projector 610 from projecting the visual information 640 onto the area 670 and/or preventing the target person from seeing a projection on the area 670. In addition, the projection of visual information 640 avoids the area 660 on the seat 650 given the determination that the area 660 is unsuitable for projecting visual information onto.

FIG. 6 also includes a depiction 600B of visual information 680 projected at time t₂ by the projector 610 within the vehicle. As shown in the depiction 600B, at time t₂, the projector 610 projects the visual information 680 onto the seat 650 used by the occupant 630 instead of avoiding the seat 650 as a surface on which to project the visual information 680. For example, while the seat 650 is identified as an obstruction in the depiction 600A and avoided as a candidate surface for projecting visual information, in the depiction 600B at time t₂, the projector 610 instead uses the surface of the seat 650 as a surface on which the visual information 680 is projected.

As previously explained, the projector 610 may be configured to project, and/or capable of projecting, visual information anywhere along the lines labeled “P” in FIG. 6, including the vehicle surface 620, the seat 650, and the occupant 630. Moreover, as previously explained, the area 670 is an area with an unsuitable surface for displaying projections of visual information. However, as shown in the depiction 600B at time t₂, when projecting the visual information 680 onto the seat 650, the projector 610 avoids the area 660 deemed unsuitable for displaying projections of visual information. Thus, as illustrated in depictions 600A and 600B, the projector 610 can at times avoid obstructions (e.g., seat 650) and, at other times, can use the obstructions (e.g., seat 650 excluding the area 660) as the surface areas for projecting visual information.

The systems and techniques discussed with respect to FIGS. 2-5 may be used to identify areas onto which certain visual information can or should be projected onto. This may include identifying visual information to project so for viewing by a target person in the vehicle.

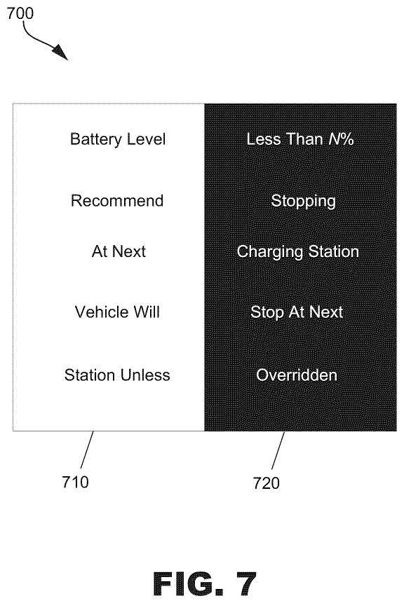

FIG. 7 illustrates an example display area 700 used to project visual information. In this example, the display area 700 includes different colors. For example, the display area 700 includes an area 710 that is white and an area 720 that is black. Visual information projected onto the display area 700 can avoid the area 710 or the area 720, or can be configured to be projected (and discernible) onto both the area 710 and the area 720. For example, if the visual information includes white colors, the projection of the visual information can use the area 720 that is black and avoid the area 710 that is white. As another example, when projecting the visual information in both the area 710 and the area 720, the visual information can include a portion that is darker than white which can be displayed in the area 710 that is white, and a portion that is lighter than black which can be displayed in the area 720 that is black, as shown in FIG. 7.

For example, visual information projected onto the display area 700 can include black text projected onto the area 710 that is white and white text projected onto the area 720 that is black, to ensure that the visual information projected on both the white and black areas (e.g., area 710 and area 720, respectively) can be discernible to the human eye. As shown in FIG. 7, the text of the visual information projected onto the display area 700 includes a black text projected on the area 720 that is black and white text that is projected onto the area 710 that is white. While FIG. 7 uses black and white colors, other examples may implement other colors in addition to or in lieu of black and white. Any color may be selected to be projected onto a display surface or portion of that display surface as long as such color allows the information to be discernible to the human eye when projected onto a surface with an associated color. While FIG. 7 illustrates use of colors when projecting visual information, other examples may similarly implement other attributes such as, for example, texture, brightness, contrast, size, etc.

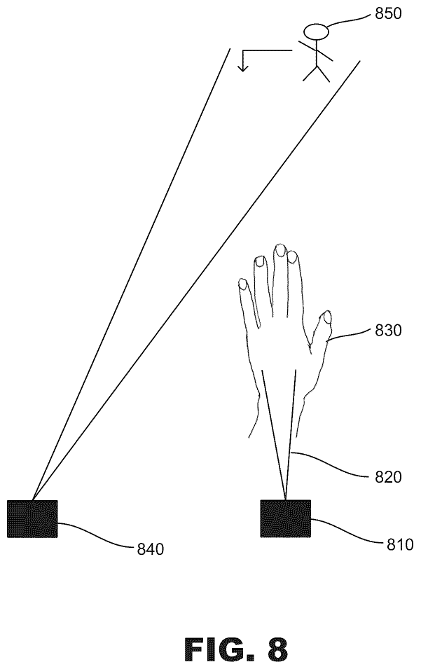

FIG. 8 illustrates an example object 830 that is in a position relative to a first projector 810 that would block a projection made by that first projector 810. In this example, the object 830 is a hand. As shown in FIG. 8, the hand is in a position that would block projected light 820 emitted by the first projector 810. Thus, the object 830 (e.g., the hand) can be avoided in projections of visual information by selecting a different target area for projecting visual information that would avoid the object 830 or by using a different projector to project the visual information such that the different projector can project the visual information from a different position that would avoid the object 830.

FIG. 8 also shows a second projector 840 configured to project visual information onto any selected display surface. In the previous example where the object 830 would block a projection of visual information from the first projector 810, the local computing device 110 of the vehicle can use the second projector 840 to project visual information and avoid the object 830 from blocking the projection of visual information from the second projector 840.

For example, assume that a first occupant (not shown) of the vehicle may be seated in a back seat of the vehicle when a second occupant is entering the vehicle. In an instance when the first occupant moves a hand (e.g., object 830) within a path of emitted light 820 from the first projector 810, the emitted light 820 (and any associated information) would be blocked by the hand from view of the second occupant. To avoid the hand when projecting visual information, the local computing device 110 can select a second projector 840 to project visual information 850 onto a surface of the vehicle that is visible to the second occupant in order to avoid the hand blocking the view of the visual information 850 by the second occupant.

The second projector 840 may be selected to project the visual information 850 onto a display surface according to any portions of the process 300 shown in FIG. 3, the process 400 shown in FIG. 4, and/or the process 500 shown in FIG. 5. The selection of the second projector 840 to project the visual information 850 can include collecting sensor data (e.g., camera sensor data, LIDAR data, RADAR data, TOF sensor data, IMU data, ultrasound sensor data, and/or data from any other type of sensor) and using the collected sensor data to identify that light projections from the first projector 810 would be blocked from a view of the second occupant. The local computing device 110 may thus determine to use the second projector 840 to project the visual information 850 onto a selected display area.

After the first occupant moves their hand (e.g., object 830), the hand may no longer interfere with a projection of visible light 820 from the first projector 810. Accordingly, local computing device 110 may then use or select the first projector 810 project visual information onto the selected display area, as previously described. In some cases, when implementing the first projector 810, the local computing device 110 can turned off the second projector 840, reduce a power mode of the second projector 840, use the second projector 840 in conjunction with the first projector 810 to project visual information, or use the second projector 840 for other purposes.

In some cases, multiple projectors can be used together to project visual information. For example, each projector can project a portion of visual information and the portions from the different projectors can create a composite projection for a target person. In some examples, portions from different projectors can be fused or can be aligned in respective positions such that the different portions of visual information together appear as a single or composite projection.

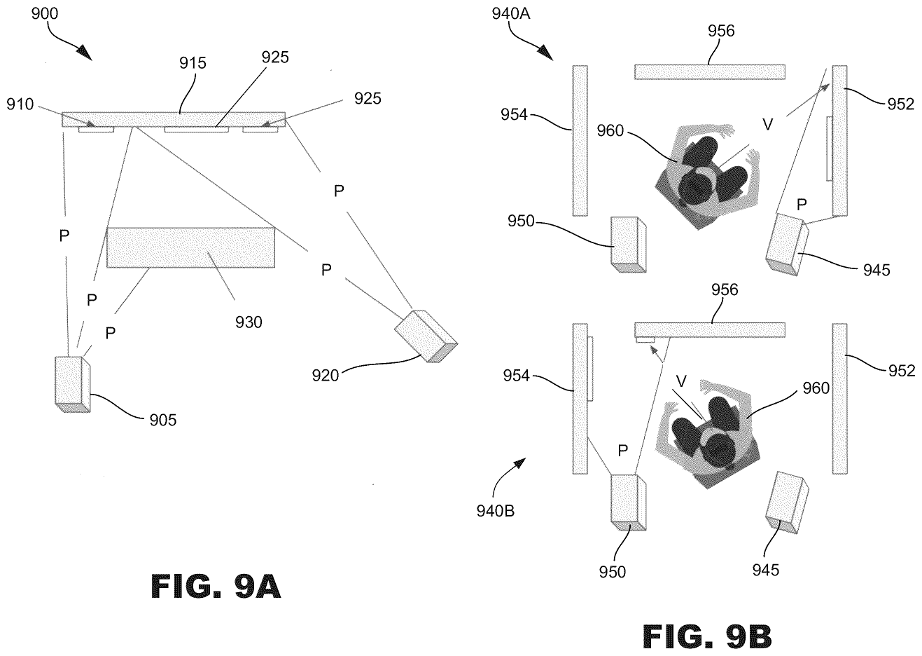

FIG. 9A illustrates an example scene 900 with multiple projectors projecting portions of visual information onto different portions of a surface of a vehicle (e.g., AV 102). The example scene 900 includes a first projector 905, a second projector 920, a vehicle surface 915, and an obstruction 930. The projector 905 can project a visual information portion 910 onto a portion of the surface 915, and avoid projecting visual information onto the obstruction 930 (e.g., avoid using the obstruction 930 as a display surface) and/or prevent the obstruction 930 from blocking the projection of the visual information portion 910.

If the position (e.g., angle, distance, location, etc.) of the first projector 905 relative to the obstruction 930 and surface 915 prevents the first projector 905 from projecting an entire portion of visual information onto the surface 915 without at least some of the projection being obstructed by the obstruction 930, the local computing device 110 can trigger the second projector 920 to project a second visual information portion 925 onto the surface 915. This can allow the first projector 905 and the second projector 920 to project an entire portion of visual information together, without any of the entire portion of visual information being obstructed by the obstruction 930.

In some examples, the first visual information portion 910 and the second visual information portion 925 can together create a single, composite, or entire visual information projection. For example, assume that the local computing device 110 intends to project a scene onto the surface 915 but neither the first projector 905 nor the second projector 920 alone/individually can project the entire scene without at least a portion of the scene being blocked by the obstruction 930. In this example, the local computing device 110 can use the first projector 905 to project onto the surface 915 a first portion of the scene represented by the first visual information portion 910, and the second projector 920 to project onto the surface 915 a second portion of the scene represented by the second visual information portion 925. The first portion of the scene (e.g., the first visual information portion 910) and the second portion of the scene (e.g., the second visual information portion 925) can together make up the entire scene to be projected. Thus, by using both the first projector 905 and the second projector 920 to project different portions of the scene onto the surface 915, the local computing device 110 can ensure that the entire scene is projected onto the surface 915 without being obstructed by the obstruction 930.

FIG. 9B illustrates projections based on a target person's attention. In this example, a first projection 940A is produced at a first time based on an attention of an occupant 960 of the vehicle. Here, the vehicle includes a first projector 945 and a second projector 950. The local computing device 110 has identified candidate surface 952, candidate surface 954, and candidate surface 956 as potential surfaces for projecting visual information. In the first projection 940A, the occupant 960 is looking towards the candidate surface 952. Accordingly, the local computing device 110 can trigger the first projector 945 to project the visual information onto the candidate surface 952 to ensure the visual information is seen by the occupant 960 given the occupant's eye gaze.

In some examples, the local computing device 110 can obtain sensor data depicting the occupant 960 and one or more areas around the occupant 960, such as the candidate surfaces 952, 954, and/or 956. The local computing device 110 can use the sensor detect to detect an eye gaze of the occupant 960. The local computing device 110 can determine that the occupant 960 is looking at the candidate surface 952 based on the detected eye gaze. The local computing device 110 can also use the sensor data to detect whether there are any obstructions in the scene and to determine which projector to use to project the visual information onto the candidate surface 952.

For example, the local computing device 110 can determine, based on the sensor data, the pose of the occupant 960, the location of the candidate surface 952, and the positions of the first projector 945 and the second projector 950 relative to the occupant 960 and the candidate surface 952. Based on this information, the local computing device 110 can then determine that the first projector 945 has an unobstructed projection path to the candidate surface 952, and that a projection path from the second projector 950 to the candidate surface 952 is obstructed by the occupant 960. Accordingly, the local computing device 110 can select to use the first projector 945 to project the visual information onto the candidate surface 952. The local computing device 110 can send an instruction/command to the first projector 945 to trigger the first projector 945 to project the visual information onto the candidate surface 952. This way, the local computing device 110 can intelligently select a candidate surface to project the visual information on based on where the occupant 960 is looking (e.g., based on the attention of the occupant 960).

FIG. 9B also shows a second projection 940B at a second time. The second projection 940B produced at the second time can similarly be based on an attention of the occupant 960 of the vehicle. As shown, the occupant 960 is no longer looking towards the candidate surface 952, and is instead looking towards the candidate surface 956. Accordingly, the local computing device 110 can trigger the second projector 950 to project the visual information onto the candidate surface 956 to ensure the visual information is seen by the occupant 960 given the occupant's eye gaze.

In some examples, the local computing device 110 can obtain sensor data depicting the occupant 960 and one or more areas around the occupant 960, such as the candidate surfaces 952, 954, and/or 956. The local computing device 110 can use the sensor detect to detect an eye gaze of the occupant 960. The local computing device 110 can determine that the occupant 960 is looking at the candidate surface 956 based on the detected eye gaze. The local computing device 110 can also use the sensor data to detect whether there are any obstructions in the scene and to determine which projector to use to project the visual information onto the candidate surface 956.

For example, the local computing device 110 can determine, based on the sensor data, the pose of the occupant 960, the location of the candidate surface 956, and the positions of the first projector 945 and the second projector 950 relative to the occupant 960 and the candidate surface 956. Based on this information, the local computing device 110 can then determine that the second projector 950 has an unobstructed projection path to the candidate surface 956, and that a projection path from the first projector 945 to the candidate surface 956 is obstructed by the occupant 960. Accordingly, the local computing device 110 can select to use the second projector 950 to project the visual information onto the candidate surface 956. The local computing device 110 can send an instruction/command to the second projector 950 to trigger the second projector 950 to project the visual information onto the candidate surface 956. This way, the local computing device 110 can intelligently select a candidate surface to project the visual information on based on where the occupant 960 is looking (e.g., based on the attention of the occupant 960).

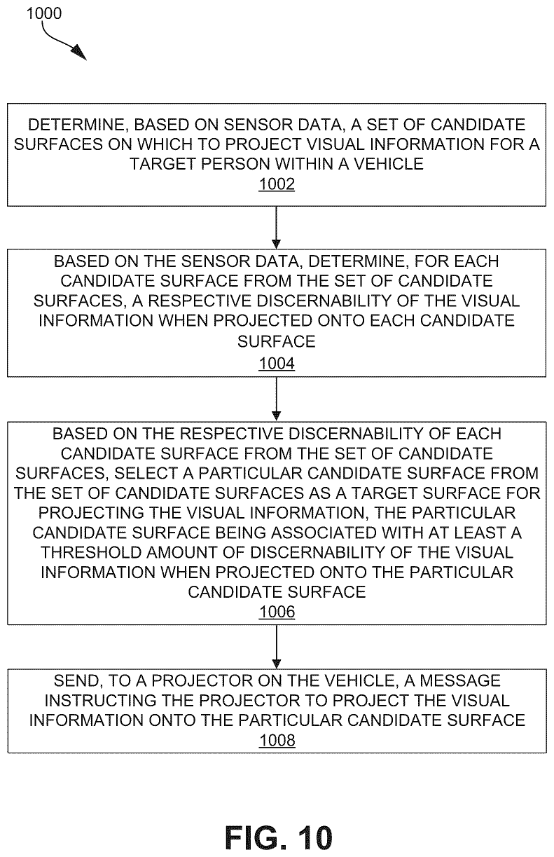

FIG. 10 is a flowchart illustrating an example process 1000 for projecting visual information onto surfaces of a vehicle (e.g., AV 102). At block 1002, the process 1000 can include determining, based on sensor data, a set of candidate surfaces on which to project visual information for a target person within a vehicle. The set of candidate surfaces can reside in an interior (e.g., interior 200) of the vehicle.

At block 1004, the process 1000 can include based on the sensor data, determine, for each candidate surface from the set of candidate surfaces, a respective discernability of the visual information when projected onto each candidate surface. In some examples, the respective discernability is determined based on attributes of the candidate surface and the visual information.

In some examples, determining the respective discernability of the visual information when projected onto each candidate surface can include comparing one or more first attributes of the candidate surface with one or more second attributes of the visual information; and determining the respective discernability of the visual information when projected onto each candidate surface based on the comparing of one or more first attributes of the candidate surface with one or more second attributes of the visual information. In some cases, the one or more first attributes and the one or more second attributes can include color, texture, brightness levels, one or more dimensions, and/or one or more visible patterns.

At block 1006, the process 1000 can include selecting, based on the respective discernability of each candidate surface from the set of candidate surfaces, a particular candidate surface from the set of candidate surfaces as a target surface for projecting the visual information. In some examples, the particular candidate surface can include or can be associated with at least a threshold amount of discernability of the visual information when projected onto the particular candidate surface.

At block 1008, the process 1000 can include sending, to a projector on the vehicle, a message instructing the projector to project the visual information onto the particular candidate surface.

In some aspects, the process 1000 can include determining, based on the sensor data, whether there are any obstructions within a projection path from the projector to the particular candidate surface; and selecting the particular candidate surface as the target surface for projecting the visual information further based on a determination that there are no obstructions within the projection path from the projector to the particular candidate surface.

In some aspects, the process 1000 can include determining, based on the sensor data, whether there are any obstructions within a projection path from the projector to the particular candidate surface; determining that there are one or more obstructions within the projection path from the projector to the particular candidate surface; in response to determining that there are one or more obstructions within the projection path from the projector to the particular candidate surface, selecting a different candidate surface from the set of candidate surfaces to project at least a portion of visual information; and projecting at least the portion of visual information onto the different candidate surface.

In some examples, selecting a different candidate surface from the set of candidate surfaces to project at least a portion of visual information can include determining, based on the sensor data, whether there are any obstructions within respective projection paths from the projector to additional candidate surfaces from the set of candidate surfaces; determining that there are no obstructions within the respective projection path from the projector to the different candidate surface, the different candidate surface including one of the additional candidate surfaces; and selecting the different candidate surface as an additional target surface for projecting at least the portion of visual information based on the determination that there are no obstructions within the respective projection path from the projector to the different candidate surface and a determination a discernability of at least the portion of visual information when projected onto the different candidate surface exceeds a threshold.

In some aspects, the process 1000 can include determining, based on the sensor data, an eye gaze of the target person; based on the eye gaze of the target person, determine that the target person is looking at a different candidate surface from the set of candidate surfaces; and based on the determining that the target person is looking at the different candidate surface, project the visual information and/or additional visual information onto the different candidate surface.

In some aspects, the process 1000 can include, prior to projecting the visual information and/or the additional visual information onto the different candidate surface, determining that there are no obstructions within a projection path from the projector to the different candidate surface; and determining that a discernability of the at least one of the visual information and the additional visual information when projected onto the different candidate surface exceeds a threshold discernibility.

In some aspects, the process 1000 can include determining, based on the sensor data, whether there are any obstructions within a projection path from the projector to the particular candidate surface; determining that there are one or more obstructions within the projection path from the projector to the particular candidate surface; in response to determining that there are one or more obstructions within the projection path from the projector to the particular candidate surface, determining whether there are any obstructions within an additional projection path from an additional projector within the vehicle to the particular candidate surface; based on a determination that there are no obstructions within the additional projection path from the additional projector within the vehicle to the particular candidate surface, selecting the additional projector to project at least one of the visual information and additional visual information onto the particular candidate surface; and projecting the at least one of the visual information and additional visual information onto the particular candidate surface.

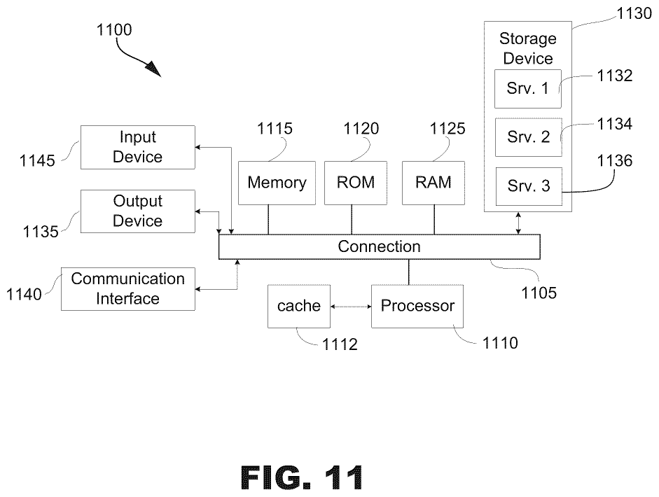

FIG. 11 illustrates an example processor-based system with which some aspects of the subject technology can be implemented. For example, processor-based system 1100 can be any computing device making up, or any component thereof in which the components of the system are in communication with each other using connection 1105. Connection 1105 can be a physical connection via a bus, or a direct connection into processor 1110, such as in a chipset architecture. Connection 1105 can also be a virtual connection, networked connection, or logical connection.

In some examples, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (Central Processing Unit (CPU) or processor) 1110 and connection 1105 that couples various system components including system memory 1115, such as Read-Only Memory (ROM) 1120 and Random-Access Memory (RAM) 1125 to processor 1110. Computing system 1100 can include a cache of high-speed memory 1112 connected directly with, in close proximity to, or integrated as part of processor 1110.

Processor 1110 can include any general-purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms known to those of skill in the art. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 1102.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 1130 can include software services, servers, services, etc., that when the code that defines such software is executed by the processor 1110, it causes the system 1100 to perform a function. In some embodiments, a hardware service that performs a particular function can include the software component stored in a computer-readable medium in connection with the necessary hardware components, such as processor 1110, connection 1105, output device 1135, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing blocks of the methods disclosed herein. The particular sequence of such executable instructions or associated data structures represents examples of corresponding acts for implementing the functions described in such blocks.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The present disclosure may be directed to methods and apparatus that evaluate received sensor data such that information may be provided to users (individuals) that enter, reside in, or that exit a vehicle. Methods of the present disclosure may be implemented as a non-transitory computer-readable storage media where a processor executes instructions of a program out of a memory. As such, aspects of the present disclosure include methods, systems, and non-transitory computer-readable storage media.

In one instance, a method may include evaluating received sensor data to identify a location of a display area internal to a vehicle to project an indication, the evaluation may be performed according to a set of projection rules associated with the vehicle that cross-reference respective projection parameters with respective projection conditions. Here, a condition associated with the display area may be one of the respective projection conditions. This method may also include identifying that the condition is associated with the display area, identifying that a projection parameter of the respective projection parameters needs to be updated according to a rule of the set of projection rules based on the set of projection rules associating the projection parameter with the identified condition, generating an image based on an update to the projection parameter according to the rule, and projecting the indication onto the location of the display area after the update to the projection parameter.

This method may also include the block of identifying that the identified condition includes a first color. This projection parameter may correspond to a color of the projected indication and the updated projection parameter may identify a second color that is different from the first color.

In certain instances, the method may include identifying a location of a potential display area based on the evaluation of the received sensor data, the location of the potential display area may be different from the location of the display area and the method may continue by identifying that the location of the potential display area includes a pattern, and identifying that the location of the potential display area is not suitable for projecting the indication onto based on the pattern being included in the location of the potential display area.

The method may also include the blocks of identifying that an object is located between the location of the display area and a first projector capable of projecting the indication and may continue by identifying that a second projector is capable of projecting the indication onto the location of the display area based on the object not being located between the second projector and the location of the display area. The indication may then be projected onto the location of the display area by the second projector.

Alternatively, or additionally, the method may also include tracking motion of the display area and moving the projection based on the tracking of the motion of the display area.

In yet other instances, the method may also include identifying that a user is entering the vehicle and identifying that the user should be directed to sit in a particular seat of the vehicle. This indication may direct the user to sit in the particular seat of the vehicle. When the user exits the vehicle, the method may identify that the user is leaving the vehicle and identify that a personal effect is located at a resting location as the user leaves the vehicle. A projection may then highlight the personal effect located at the resting location of the user.

A system consistent with the present disclosure may include one or more sensors that sense objects in a vehicle, a projector configured to project images on identified areas within the vehicle, a memory, and a processor that executes instructions out of the memory. Here again the processor may execute instructions out of the memory to evaluate data sensed by the one or more sensors to identify a location of a display area internal to the vehicle to project an indication. This evaluation may be performed according to a set of projection rules associated with the vehicle and these rules may cross-reference respective projection parameters with respective projection conditions. A condition associated with the display area may be one of the respective projection conditions. The processor may then identify that the condition is associated with the display area, identify that a projection parameter of the respective projection parameters needs to be updated according to a rule of the set of projection rules based on the set of projection rules associating the projection parameter with the identified condition. The processor may then generate an image based on an update to the projection parameter according to the rule. The projector may then project the indication onto the location of the display area after the update to the projection parameter. The system may also include a second projector that may be used to project images on surfaces of the vehicle when the processor identifies that an object is located between the first projector and the display area.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. An apparatus comprising: memory; and one or more processors coupled to the memory, the one or more processors being configured to: determine, based on sensor data, a set of candidate surfaces on which to project visual information for a target person within a vehicle, the set of candidate surfaces residing in an interior of the vehicle; based on the sensor data, determine, for each candidate surface from the set of candidate surfaces, a respective discernability of the visual information when projected onto each candidate surface, the respective discernability being determined based on attributes of the candidate surface and the visual information; based on the respective discernability of each candidate surface from the set of candidate surfaces, select a particular candidate surface from the set of candidate surfaces as a target surface for projecting the visual information, the particular candidate surface being associated with at least a threshold amount of discernability of the visual information when projected onto the particular candidate surface; and send, to a projector on the vehicle, a message instructing the projector to project the visual information onto the particular candidate surface.

Aspect 2. The system of Aspect 1, wherein the one or more processors are configured to: determine, based on the sensor data, whether there are any obstructions within a projection path from the projector to the particular candidate surface; and select the particular candidate surface as the target surface for projecting the visual information further based on a determination that there are no obstructions within the projection path from the projector to the particular candidate surface.

Aspect 3. The system of any of Aspects 1 or 2, wherein the one or more processors are configured to: determine, based on the sensor data, whether there are any obstructions within a projection path from the projector to the particular candidate surface; determine that there are one or more obstructions within the projection path from the projector to the particular candidate surface; in response to determining that there are one or more obstructions within the projection path from the projector to the particular candidate surface, select a different candidate surface from the set of candidate surfaces to project at least a portion of visual information; and project at least the portion of visual information onto the different candidate surface.

Aspect 4. The system of Aspect 3, wherein selecting a different candidate surface from the set of candidate surfaces to project at least a portion of visual information comprises: determining, based on the sensor data, whether there are any obstructions within respective projection paths from the projector to additional candidate surfaces from the set of candidate surfaces; determining that there are no obstructions within the respective projection path from the projector to the different candidate surface, the different candidate surface comprising one of the additional candidate surfaces; and selecting the different candidate surface as an additional target surface for projecting at least the portion of visual information based on the determination that there are no obstructions within the respective projection path from the projector to the different candidate surface and a determination a discernability of at least the portion of visual information when projected onto the different candidate surface exceeds a threshold.

Aspect 5. The system of any of Aspects 1 to 4, wherein determining the respective discernability of the visual information when projected onto each candidate surface comprises: comparing one or more first attributes of the candidate surface with one or more second attributes of the visual information; and determining the respective discernability of the visual information when projected onto each candidate surface based on the comparing of one or more first attributes of the candidate surface with one or more second attributes of the visual information.

Aspect 6. The system of Aspect 5, wherein the one or more first attributes and the one or more second attributes comprise at least one of color, texture, brightness levels, one or more dimensions, and one or more visible patterns.

Aspect 7. The system of any of Aspects 1 to 6, wherein the one or more processors are configured to: determine, based on the sensor data, an eye gaze of the target person; based on the eye gaze of the target person, determine that the target person is looking at a different candidate surface from the set of candidate surfaces; and based on the determining that the target person is looking at the different candidate surface, project at least one of the visual information and additional visual information onto the different candidate surface.

Aspect 8. The system of Aspect 7, wherein the one or more processors are configured to: prior to projecting at least one of the visual information and additional visual information onto the different candidate surface, determine that there are no obstructions within a projection path from the projector to the different candidate surface; and determine that a discernability of the at least one of the visual information and the additional visual information when projected onto the different candidate surface exceeds a threshold discernibility.

Aspect 9. The system of any of Aspects 1 to 8, wherein the one or more processors are configured to: determine, based on the sensor data, whether there are any obstructions within a projection path from the projector to the particular candidate surface; determine that there are one or more obstructions within the projection path from the projector to the particular candidate surface; in response to determining that there are one or more obstructions within the projection path from the projector to the particular candidate surface, determine whether there are any obstructions within an additional projection path from an additional projector within the vehicle to the particular candidate surface; based on a determination that there are no obstructions within the additional projection path from the additional projector within the vehicle to the particular candidate surface, select the additional projector to project at least one of the visual information and additional visual information onto the particular candidate surface; and project the at least one of the visual information and additional visual information onto the particular candidate surface.

Aspect 10. A method comprising: determining, based on sensor data, a set of candidate surfaces on which to project visual information for a target person within a vehicle, the set of candidate surfaces residing in an interior of the vehicle; based on the sensor data, determining, for each candidate surface from the set of candidate surfaces, a respective discernability of the visual information when projected onto each candidate surface, the respective discernability being determined based on attributes of the candidate surface and the visual information; based on the respective discernability of each candidate surface from the set of candidate surfaces, selecting a particular candidate surface from the set of candidate surfaces as a target surface for projecting the visual information, the particular candidate surface being associated with at least a threshold amount of discernability of the visual information when projected onto the particular candidate surface; and sending, to a projector on the vehicle, a message instructing the projector to project the visual information onto the particular candidate surface.

Aspect 11. The method of Aspect 10, further comprising: determining, based on the sensor data, whether there are any obstructions within a projection path from the projector to the particular candidate surface; and selecting the particular candidate surface as the target surface for projecting the visual information further based on a determination that there are no obstructions within the projection path from the projector to the particular candidate surface.

Aspect 12. The method of any of Aspects 10 to 11, further comprising: determining, based on the sensor data, whether there are any obstructions within a projection path from the projector to the particular candidate surface; determining that there are one or more obstructions within the projection path from the projector to the particular candidate surface; in response to determining that there are one or more obstructions within the projection path from the projector to the particular candidate surface, selecting a different candidate surface from the set of candidate surfaces to project at least a portion of visual information; and project at least the portion of visual information onto the different candidate surface.

Aspect 13. The method of Aspect 12, wherein selecting a different candidate surface from the set of candidate surfaces to project at least a portion of visual information comprises: determining, based on the sensor data, whether there are any obstructions within respective projection paths from the projector to additional candidate surfaces from the set of candidate surfaces; determining that there are no obstructions within the respective projection path from the projector to the different candidate surface, the different candidate surface comprising one of the additional candidate surfaces; and selecting the different candidate surface as an additional target surface for projecting at least the portion of visual information based on the determination that there are no obstructions within the respective projection path from the projector to the different candidate surface and a determination a discernability of at least the portion of visual information when projected onto the different candidate surface exceeds a threshold.

Aspect 14. The method of any of Aspects 10 to 13, wherein determining the respective discernability of the visual information when projected onto each candidate surface comprises: comparing one or more first attributes of the candidate surface with one or more second attributes of the visual information; and determining the respective discernability of the visual information when projected onto each candidate surface based on the comparing of one or more first attributes of the candidate surface with one or more second attributes of the visual information.

Aspect 15. The method of Aspect 14, wherein the one or more first attributes and the one or more second attributes comprise at least one of color, texture, brightness levels, one or more dimensions, and one or more visible patterns.

Aspect 16. The method of any of Aspects 10 to 15, further comprising: determining, based on the sensor data, an eye gaze of the target person; based on the eye gaze of the target person, determining that the target person is looking at a different candidate surface from the set of candidate surfaces; and based on the determining that the target person is looking at the different candidate surface, projecting at least one of the visual information and additional visual information onto the different candidate surface.

Aspect 17. The method of Aspect 16, further comprising: prior to projecting at least one of the visual information and additional visual information onto the different candidate surface, determining that there are no obstructions within a projection path from the projector to the different candidate surface; and determining that a discernability of the at least one of the visual information and the additional visual information when projected onto the different candidate surface exceeds a threshold discernibility.

Aspect 18. The method of any of Aspects 10 to 17, further comprising: determining, based on the sensor data, whether there are any obstructions within a projection path from the projector to the particular candidate surface; determining that there are one or more obstructions within the projection path from the projector to the particular candidate surface; in response to determining that there are one or more obstructions within the projection path from the projector to the particular candidate surface, determining whether there are any obstructions within an additional projection path from an additional projector within the vehicle to the particular candidate surface; based on a determination that there are no obstructions within the additional projection path from the additional projector within the vehicle to the particular candidate surface, selecting the additional projector to project at least one of the visual information and additional visual information onto the particular candidate surface; and projecting the at least one of the visual information and additional visual information onto the particular candidate surface.

Aspect 19. A non-transitory computer-readable medium having stored thereon instructions which, when executed by one or more processors, cause the one or more processors to perform a method according to any of Aspects 10 to 18.

Aspect 20. An autonomous vehicle comprising a computer device configured to perform a method according to any of Aspects 10 to 18.

Aspect 21. A system comprising means for performing a method according to any of Aspects 10 to 18.

Aspect 22. A computer program product having stored thereon instructions which, when executed by one or more processors, cause the one or more processors to perform a method according to any of Aspects 10 to 18.

What is claimed is:

1. An system comprising:
memory; and
one or more processors coupled to the memory, the one or more processors being configured to:
determine, based on sensor data, a set of candidate surfaces on which to project visual information for a target person within a vehicle, the set of candidate surfaces residing in an interior of the vehicle;
based on the sensor data, determine, for each candidate surface from the set of candidate surfaces, a respective discernability of the visual information when projected onto each candidate surface, the respective discernability being determined based on attributes of the candidate surface and the visual information;
based on the respective discernability of each candidate surface from the set of candidate surfaces, select a particular candidate surface from the set of candidate surfaces as a target surface for projecting the visual information, the particular candidate surface being associated with at least a threshold amount of discernability of the visual information when projected onto the particular candidate surface; and
send, to a projector on the vehicle, a message instructing the projector to project the visual information onto the particular candidate surface.

2. The system of claim 1, wherein the one or more processors are configured to:
determine, based on the sensor data, whether there are any obstructions within a projection path from the projector to the particular candidate surface; and
select the particular candidate surface as the target surface for projecting the visual information further based on a determination that there are no obstructions within the projection path from the projector to the particular candidate surface.

3. The system of claim 1, wherein the one or more processors are configured to:
determine, based on the sensor data, whether there are any obstructions within a projection path from the projector to the particular candidate surface;
determine that there are one or more obstructions within the projection path from the projector to the particular candidate surface;
in response to determining that there are one or more obstructions within the projection path from the projector to the particular candidate surface, select a different candidate surface from the set of candidate surfaces to project at least a portion of visual information; and
project at least the portion of visual information onto the different candidate surface.

4. The system of claim 3, wherein selecting a different candidate surface from the set of candidate surfaces to project at least a portion of visual information comprises:
determining, based on the sensor data, whether there are any obstructions within respective projection paths from the projector to additional candidate surfaces from the set of candidate surfaces;
determining that there are no obstructions within the respective projection path from the projector to the different candidate surface, the different candidate surface comprising one of the additional candidate surfaces; and
selecting the different candidate surface as an additional target surface for projecting at least the portion of visual information based on the determination that there are no obstructions within the respective projection path from the projector to the different candidate surface and a determination a discernability of at least the portion of visual information when projected onto the different candidate surface exceeds a threshold.

5. The system of claim 1, wherein determining the respective discernability of the visual information when projected onto each candidate surface comprises:
comparing one or more first attributes of the candidate surface with one or more second attributes of the visual information; and
determining the respective discernability of the visual information when projected onto each candidate surface based on the comparing of one or more first attributes of the candidate surface with one or more second attributes of the visual information.

6. The system of claim 5, wherein the one or more first attributes and the one or more second attributes comprise at least one of color, texture, brightness levels, one or more dimensions, and one or more visible patterns.

7. The system of claim 1, wherein the one or more processors are configured to:
determine, based on the sensor data, an eye gaze of the target person;
based on the eye gaze of the target person, determine that the target person is looking at a different candidate surface from the set of candidate surfaces; and
based on the determining that the target person is looking at the different candidate surface, project at least one of the visual information and additional visual information onto the different candidate surface.

8. The system of claim 7, wherein the one or more processors are configured to:
prior to projecting at least one of the visual information and additional visual information onto the different candidate surface, determine that there are no obstructions within a projection path from the projector to the different candidate surface; and
determine that a discernability of the at least one of the visual information and the additional visual information when projected onto the different candidate surface exceeds a threshold discernibility.

9. The system of claim 1, wherein the one or more processors are configured to:
determine, based on the sensor data, whether there are any obstructions within a projection path from the projector to the particular candidate surface;
determine that there are one or more obstructions within the projection path from the projector to the particular candidate surface;
in response to determining that there are one or more obstructions within the projection path from the projector to the particular candidate surface, determine whether there are any obstructions within an additional projection path from an additional projector within the vehicle to the particular candidate surface;
based on a determination that there are no obstructions within the additional projection path from the additional projector within the vehicle to the particular candidate surface, select the additional projector to project at least one of the visual information and additional visual information onto the particular candidate surface; and
project the at least one of the visual information and additional visual information onto the particular candidate surface.

10. A method comprising:
determining, based on sensor data, a set of candidate surfaces on which to project visual information for a target person within a vehicle, the set of candidate surfaces residing in an interior of the vehicle;
based on the sensor data, determining, for each candidate surface from the set of candidate surfaces, a respective discernability of the visual information when projected onto each candidate surface, the respective discernability being determined based on attributes of the candidate surface and the visual information;
based on the respective discernability of each candidate surface from the set of candidate surfaces, selecting a particular candidate surface from the set of candidate surfaces as a target surface for projecting the visual information, the particular candidate surface being associated with at least a threshold amount of discernability of the visual information when projected onto the particular candidate surface; and
sending, to a projector on the vehicle, a message instructing the projector to project the visual information onto the particular candidate surface.

11. The method of claim 10, further comprising:
determining, based on the sensor data, whether there are any obstructions within a projection path from the projector to the particular candidate surface; and
selecting the particular candidate surface as the target surface for projecting the visual information further based on a determination that there are no obstructions within the projection path from the projector to the particular candidate surface.

12. The method of claim 10, further comprising:
determining, based on the sensor data, whether there are any obstructions within a projection path from the projector to the particular candidate surface;
determining that there are one or more obstructions within the projection path from the projector to the particular candidate surface;
in response to determining that there are one or more obstructions within the projection path from the projector to the particular candidate surface, selecting a different candidate surface from the set of candidate surfaces to project at least a portion of visual information; and
project at least the portion of visual information onto the different candidate surface.

13. The method of claim 12, wherein selecting a different candidate surface from the set of candidate surfaces to project at least a portion of visual information comprises:
determining, based on the sensor data, whether there are any obstructions within respective projection paths from the projector to additional candidate surfaces from the set of candidate surfaces;
determining that there are no obstructions within the respective projection path from the projector to the different candidate surface, the different candidate surface comprising one of the additional candidate surfaces; and
selecting the different candidate surface as an additional target surface for projecting at least the portion of visual information based on the determination that there are no obstructions within the respective projection path from the projector to the different candidate surface and a determination a discernability of at least the portion of visual information when projected onto the different candidate surface exceeds a threshold.

14. The method of claim 10, wherein determining the respective discernability of the visual information when projected onto each candidate surface comprises:
comparing one or more first attributes of the candidate surface with one or more second attributes of the visual information; and
determining the respective discernability of the visual information when projected onto each candidate surface based on the comparing of one or more first attributes of the candidate surface with one or more second attributes of the visual information.

15. The method of claim 14, wherein the one or more first attributes and the one or more second attributes comprise at least one of color, texture, brightness levels, one or more dimensions, and one or more visible patterns.

16. The method of claim 10, further comprising:
determining, based on the sensor data, an eye gaze of the target person;
based on the eye gaze of the target person, determining that the target person is looking at a different candidate surface from the set of candidate surfaces; and
based on the determining that the target person is looking at the different candidate surface, projecting at least one of the visual information and additional visual information onto the different candidate surface.

17. The method of claim 16, further comprising:
prior to projecting at least one of the visual information and additional visual information onto the different candidate surface, determining that there are no obstructions within a projection path from the projector to the different candidate surface; and
determining that a discernability of the at least one of the visual information and the additional visual information when projected onto the different candidate surface exceeds a threshold discernibility.

18. The method of claim 10, further comprising:
determining, based on the sensor data, whether there are any obstructions within a projection path from the projector to the particular candidate surface;
determining that there are one or more obstructions within the projection path from the projector to the particular candidate surface;
in response to determining that there are one or more obstructions within the projection path from the projector to the particular candidate surface, determining whether there are any obstructions within an additional projection path from an additional projector within the vehicle to the particular candidate surface;
based on a determination that there are no obstructions within the additional projection path from the additional projector within the vehicle to the particular candidate surface, selecting the additional projector to project at least one of the visual information and additional visual information onto the particular candidate surface; and
projecting the at least one of the visual information and additional visual information onto the particular candidate surface.

19. A non-transitory computer-readable medium having stored thereon instructions which, when executed by one or more processors, cause the one or more processors to:
determine, based on sensor data, a set of candidate surfaces on which to project visual information for a target person within a vehicle, the set of candidate surfaces residing in an interior of the vehicle;
based on the sensor data, determine, for each candidate surface from the set of candidate surfaces, a respective discernability of the visual information when projected onto each candidate surface, the respective discernability being determined based on attributes of the candidate surface and the visual information;
based on the respective discernability of each candidate surface from the set of candidate surfaces, select a particular candidate surface from the set of candidate surfaces as a target surface for projecting the visual information, the particular candidate surface being associated with at least a threshold amount of discernability of the visual information when projected onto the particular candidate surface; and
send, to a projector on the vehicle, a message instructing the projector to project the visual information onto the particular candidate surface.

20. The non-transitory computer-readable medium of claim 19, wherein the instructions, when executed by one or more processors, cause the one or more processors to:
determine, based on the sensor data, whether there are any obstructions within a projection path from the projector to the particular candidate surface; and
select the particular candidate surface as the target surface for projecting the visual information further based on a determination that there are no obstructions within the projection path from the projector to the particular candidate surface.
